(19) United States
(12) Patent Application Publication
(10) Pub. No.: US 2024/0408737 A1
(43) Pub. Date: Dec. 12, 2024

(54) DRIVER-DRILL

(71) Applicant: MAKITA CORPORATION, ANJO-SHI (JP)

(72) Inventors: Takao KUROYANAGI, Anjo-shi (JP); Yuta ARAKI, Anjo-Shi (JP); Shizuki OKAJIMA, Anjo-Shi (JP); Taisei OSAWA, Anjo-Shi (JP); Shingo SAKURAYAMA, Anjo-Shi (JP)

(21) Appl. No.: 18/680,038

(22) Filed: May 31, 2024

(30) Foreign Application Priority Data
Jun. 6, 2023 (JP) 2023-093267
Feb. 27, 2024 (JP) 2024-027661

(51) Int. Cl. B25F 5/00; B23B 45/00; B23B 45/02; B25B 21/02

(52) U.S. Cl. CPC B25F 5/001; B23B 45/008; B23B 45/02; B25B 21/026; B25F 5/008

(57) ABSTRACT

A driver-drill (1) includes a motor (6) having a stator (61) and a rotor (62); an output part (8) including: a spindle (81), which is disposed more forward than the motor and, in response to application of a rotational force transmitted from the rotor, is rotated around a rotational axis (AX) extending in the front-rear direction; and a chuck (82), which is mounted on the spindle; and a speed-reducing mechanism (30), which is configured to rotate the output part at a rotational speed that is lower than the rotational speed of the rotor but at a higher torque. The maximum fastening torque of the output part is 160 N·m or more.

### CROSS-REFERENCE TO RELATED APPLICATIONS

This application claims priority to Japanese patent application no. 2023-093267 filed on Jun. 6, 2023, and to Japanese patent application no. 2024-027661 filed on Feb. 27, 2024, the contents of both of which are fully incorporated herein by reference.

### TECHNICAL FIELD

The techniques disclosed in the present specification relate to a driver-drill, such as a hammer driver-drill.

### BACKGROUND ART

US 2021/331306 A1 discloses a driver-drill related to the present disclosure.

### SUMMARY OF THE INVENTION

It is one non-limiting object of the present teachings to disclose techniques for increasing the torque of an output part of a driver-drill. In addition or in the alternative, it is one non-limiting object of the present teachings to disclose techniques for shortening the overall length of a driver-drill.

In one non-limiting aspect of the present teachings, a driver-drill may comprise: a motor, which comprises a stator and a rotor; an output part comprising: a spindle, which is disposed more forward than the motor and, in response to application of a rotational force transmitted from the rotor, is rotated around a rotational axis extending in the front-rear direction; and a chuck, which is mounted on the spindle; and a speed-reducing mechanism, which is configured (adapted) to rotate the output part at a rotational speed that is lower than the rotational speed of the rotor but at a higher torque. The maximum fastening torque of the output part may be 160 N·m or more.

In another non-limiting aspect of the present teachings, a driver-drill may comprise: a motor, which comprises a stator and a rotor; an output part comprising: a spindle, which is disposed more forward than the motor and, in response to application of a rotational force transmitted from the rotor, is rotated around a rotational axis extending in the front-rear direction; and a chuck, which is mounted on the spindle; a speed-reducing mechanism, which is configured to rotate the output part at a rotational speed that is lower than the rotational speed of the rotor but at a higher torque; an enclosing member, which covers the periphery and a rear portion of the motor; and a casing, which is connected to a front portion of the enclosing member and houses the speed-reducing mechanism. A front-end portion of the chuck may be disposed more forward than the casing. The speed-reducing mechanism may be a three-stage, variable-speed mechanism. An overall length, which is the distance in the front-rear direction between a rear end of the enclosing member and a front end of the chuck, may be 210 mm or less.

According to one or more aspects disclosed in the present specification, the output part of the driver-drill can be driven at a higher torque. In addition or the alternative, according to one or more aspects disclosed in the present specification, the overall length of the driver-drill can be shortened.

### BRIEF DESCRIPTION OF THE DRAWINGS

FIG. 1 is an oblique view, viewed from the front, that shows a driver-drill according to an embodiment.

FIG. 2 is an oblique view, viewed from the rear, that shows the driver-drill according to the embodiment.

FIG. 3 is a side view that shows the driver-drill according to the embodiment.

FIG. 4 is a cross-sectional view that shows the driver-drill according to the embodiment.

FIG. 5 is a cross-sectional view that shows a portion of the driver-drill according to the embodiment.

FIG. 6 is an oblique view, viewed from the right front, that shows a portion of a speed-reducing mechanism according to the embodiment.

FIG. 7 is an oblique view, viewed from the front, that shows a portion of the driver-drill according to the embodiment.

FIG. 8 is a side view that shows a portion of the driver-drill according to the embodiment.

FIG. 9 is a cross-sectional view that shows a portion of the driver-drill according to the embodiment.

FIG. 10 is an exploded, oblique view that shows the speed-reducing mechanism according to the embodiment.

FIG. 11 is an oblique view, viewed from the rear, that shows a portion of the speed-reducing mechanism according to the embodiment.

FIG. 12 is an oblique, broken view, viewed from the rear, that shows a portion of the speed-reducing mechanism according to the embodiment.

FIG. 13 is a side view that shows a first speed-changing mechanism and a second speed-changing mechanism according to the embodiment.

FIG. 14 is an oblique view, viewed from the lower-right rear, that shows the first speed-changing mechanism and the second speed-changing mechanism according to the embodiment.

FIG. 15 is a drawing, viewed from above, of the driver-drill when the speed-reducing mechanism has been set to a low-speed mode (speed “1”) according to the embodiment.

FIG. 16 is a cross-sectional view that shows the driver-drill when the speed-reducing mechanism has been set to the low-speed mode (speed “1”) according to the embodiment.

FIG. 17 is a cross-sectional view that shows the driver-drill when the speed-reducing mechanism has been set to the low-speed mode (speed “1”) according to the embodiment.

FIG. 18 shows the internal structure of the driver-drill when the speed-reducing mechanism has been set to the low-speed mode (speed “1”) according to the embodiment.

FIG. 19 is a drawing, viewed from above, of the driver-drill when the speed-reducing mechanism has been set to a medium-speed mode (speed “2”) according to the embodiment.

FIG. 20 is a cross-sectional view that shows the driver-drill when the speed-reducing mechanism has been set to the medium-speed mode (speed “2”) according to the embodiment.

FIG. 21 is a cross-sectional view that shows the driver-drill when the speed-reducing mechanism has been set to the medium-speed mode (speed “2”) according to the embodiment.

FIG. 22 shows the internal structure of the driver-drill when the speed-reducing mechanism has been set to the medium-speed mode (speed “2”) according to the embodiment.

FIG. 23 is a drawing, viewed from above, of the driver-drill when the speed-reducing mechanism has been set to a high-speed mode (speed “3”) according to the embodiment.

FIG. 24 is a cross-sectional view that shows the driver-drill when the speed-reducing mechanism has been set to the high-speed mode (speed “3”) according to the embodiment.

FIG. 25 is a cross-sectional view that shows the driver-drill when the speed-reducing mechanism has been set to the high-speed mode (speed “3”) according to the embodiment.

FIG. 26 shows the internal structure of the driver-drill when the speed-reducing mechanism has been set to the high-speed mode (speed “3”) according to the embodiment.

FIG. 27 shows the relationship between the fastening torque and the overall length of the driver-drill according to the embodiment.

FIG. 28 shows the relationship between the motor torque and the gear ratio of the driver-drill according to the embodiment.

FIG. 29 explains working/operating conditions under which the driver-drill can perform according to the embodiment.

FIG. 30 explains a motor according to the embodiment.

FIG. 31 is a graph, which shows the relationship between the torque and the motor characteristics of an output part in a high-speed mode when a first battery pack having a rated voltage of 40 V and a battery capacity of 8 Ah is used, according to the embodiment.

FIG. 32 is a graph, which shows the relationship between the torque and the motor characteristics of the output part in a medium-speed mode when the first battery pack having a rated voltage of 40 V and a battery capacity of 8 Ah is used, according to the embodiment.

FIG. 33 is a graph, which shows the relationship between the torque and the motor characteristics of the output part in the medium-speed mode when a second battery pack having a rated voltage of 40 V and a battery capacity of 2 Ah is used, according to the embodiment.

### DETAILED DESCRIPTION

As was mentioned above, a driver-drill may comprise: a motor, which comprises a stator and a rotor; an output part comprising: a spindle, which is disposed more forward than the motor and, in response to application of a rotational force transmitted from the rotor, is rotated around a rotational axis extending in the front-rear direction; and a chuck, which is mounted on the spindle; and a speed-reducing mechanism, which is configured to rotate the output part at a rotational speed that is lower than the rotational speed of the rotor but at a higher torque. The maximum fastening torque of the output part may be 160 N·m or more.

According to the above-mentioned configuration, the output part of the driver-drill can be driven at a higher torque.

In one or more embodiments, the speed-reducing mechanism may be a three-stage, variable-speed mechanism.

According to the above-mentioned configuration, the output part will rotate at a suitable torque (or in a suitable torque range) in accordance with the requirements for a particular operation/processing (work details).

In one or more embodiments, a driver-drill may comprise: a motor, which comprises a stator and a rotor; an output part comprising: a spindle, which is disposed more forward than the motor and, in response to application of a rotational force transmitted from the rotor, is rotated around a rotational axis extending in the front-rear direction; and a chuck, which is mounted on the spindle; and a speed-reducing mechanism, which is configured to rotate the output part at a rotational speed that is lower than the rotational speed of the rotor but at a higher torque. The speed-reducing mechanism may be a three-stage, variable-speed mechanism. The maximum fastening torque of the output part may be 155 N·m or more.

According to the above-mentioned configuration, the output part of the driver-drill can be driven at a higher torque.

As was also mentioned above, a driver-drill may comprise: a motor, which comprises a stator and a rotor; an output part comprising: a spindle, which is disposed more forward than the motor and, in response to application of a rotational force transmitted from the rotor, is rotated around a rotational axis extending in the front-rear direction; and a chuck, which is mounted on the spindle; a speed-reducing mechanism, which is configured to rotate the output part at a rotational speed that is lower than the rotational speed of the rotor but at a higher torque; an enclosing member, which covers the periphery and a rear portion of the motor; and a casing, which is connected to a front portion of the enclosing member and houses the speed-reducing mechanism. A front-end portion of the chuck may be disposed forward of the casing. The speed-reducing mechanism may be a three-stage, variable-speed mechanism. An overall length, which is the distance in the front-rear direction between a rear end of the enclosing member and a front end of the chuck, may be 210 mm or less.

According to the above-mentioned configuration, the overall length of the driver-drill can be shortened.

In one or more embodiments, the driver-drill may comprise a hammer (percussion) mechanism, which causes the output part to hammer (to be hammered) in an axial direction of the output part. The casing may house a power-transmission mechanism, which comprises the speed-reducing mechanism and the hammer mechanism. The dimension of the motor in the front-rear direction may be 50 mm. The dimension of the power-transmission mechanism in the front-rear direction may be 90 mm. The dimension of the chuck in the front-rear direction may be 50 mm.

According to the above-mentioned configuration, the overall length of the driver-drill can be shortened.

In one or more embodiments, the outer diameter of the spindle on which the chuck is mounted may be 9/16 inch.

According to the above-mentioned configuration, the spindle, which has high strength and is adapted to making the output part high torque, is provided.

In one or more embodiments, the speed-reducing mechanism may comprise: a first planetary-gear mechanism comprising: a first-stage portion comprising a plurality of first planet gears disposed around a sun gear rotated by the rotor and a first internal gear disposed around the plurality of first planet gears; and a second-stage portion, the speed-reduction ratio of which differs from that of the first-stage portion and comprising a plurality of second planet gears disposed around the sun gear and a second internal gear disposed around the plurality of second planet gears; a second planetary-gear mechanism, which is disposed more forward than the first planetary-gear mechanism and is driven by the rotational force of the first planetary-gear mechanism; and a third planetary-gear mechanism, which is disposed more forward than the second planetary-gear mechanism and is driven by the rotational force of the second planetary-gear mechanism. The output part may be rotated by the rotational force of the rotor transmitted via the third planetary-gear mechanism.

According to the above-mentioned configuration, the output part will rotate at a suitable torque (or in a suitable torque range) in accordance with the requirements for a particular operation/processing.

In one or more embodiments, the speed-reduction ratio of the second-stage portion may be larger than the speed-reduction ratio of the first-stage portion.

According to the above-mentioned configuration, the output part will rotate at a suitable torque (or in a suitable torque range) in accordance with the requirements for a particular operation/processing.

In one or more embodiments, the speed-reduction ratio of the second planetary-gear mechanism and the speed-reduction ratio of the third planetary-gear mechanism may be smaller than the speed-reduction ratio of the first-stage portion. The speed-reduction ratio of the second planetary-gear mechanism may be smaller than the speed-reduction ratio of the third planetary-gear mechanism.

According to the above-mentioned configuration, the output part will rotate at a suitable torque (or in a suitable torque range) in accordance with the requirements for a particular operation/processing.

In one or more embodiments, the speed-reducing mechanism being at (having been set to) speed “1” may mean that the second-stage portion of the first planetary-gear mechanism, the second planetary-gear mechanism, and the third planetary-gear mechanism are being used (are mechanically connected to operate together). The speed-reducing mechanism being at (having been set to) speed “2” may mean that the second-stage portion of the first planetary-gear mechanism and the third planetary-gear mechanism are being used (are mechanically connected to operate together). The speed-reducing mechanism being at (having been set to) speed “3” may mean that the first-stage portion of the first planetary-gear mechanism and the third planetary-gear mechanism are being used (are mechanically connected to operate together).

According to the above-mentioned configuration, the output part will rotate at a suitable torque (or in a suitable torque range) in accordance with the requirements for a particular operation/processing.

Embodiments according to the present disclosure will be explained below, with reference to the drawings, but the present disclosure is not limited thereto. Structural elements of the embodiments explained below can be combined where appropriate. In addition, there are also situations in which some of the structural elements are not used.

In the embodiment, positional relationships among the parts are explained using the terms left, right, front, rear, up, and down. These terms indicate relative position or direction, wherein the center of the driver-drill is the reference.

The driver-drill comprises the motor. In the embodiment, the direction parallel to rotational axis AX of the motor is called the axial direction where appropriate, the direction that goes around rotational axis AX is called the circumferential direction or the rotational direction where appropriate, and the radial direction of rotational axis AX is called the radial direction where appropriate.

In the embodiment, rotational axis AX extends in a front-rear direction. The axial direction and the front-rear direction coincide with each other. One side in the axial direction is forward, and the other side in the axial direction is rearward. In addition, in the radial direction, a location that is proximate to or a direction that approaches rotational axis AX is called radially inward where appropriate, and a location that is distant from or a direction that leads away from rotational axis AX is called radially outward where appropriate.

### First Embodiment

### Overview of Driver-Drill

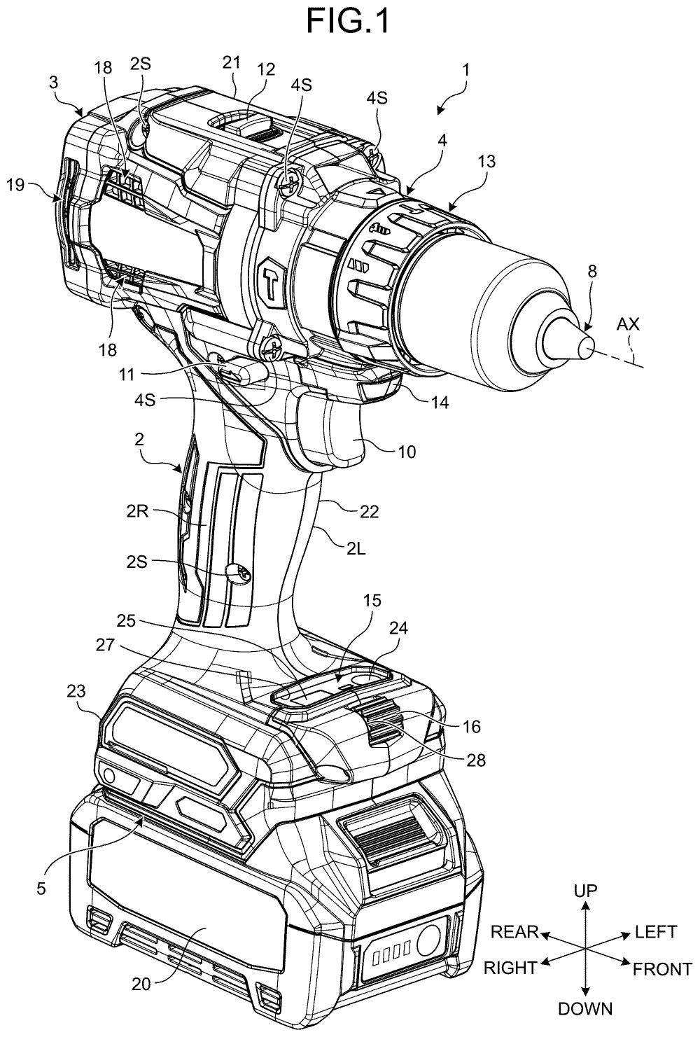

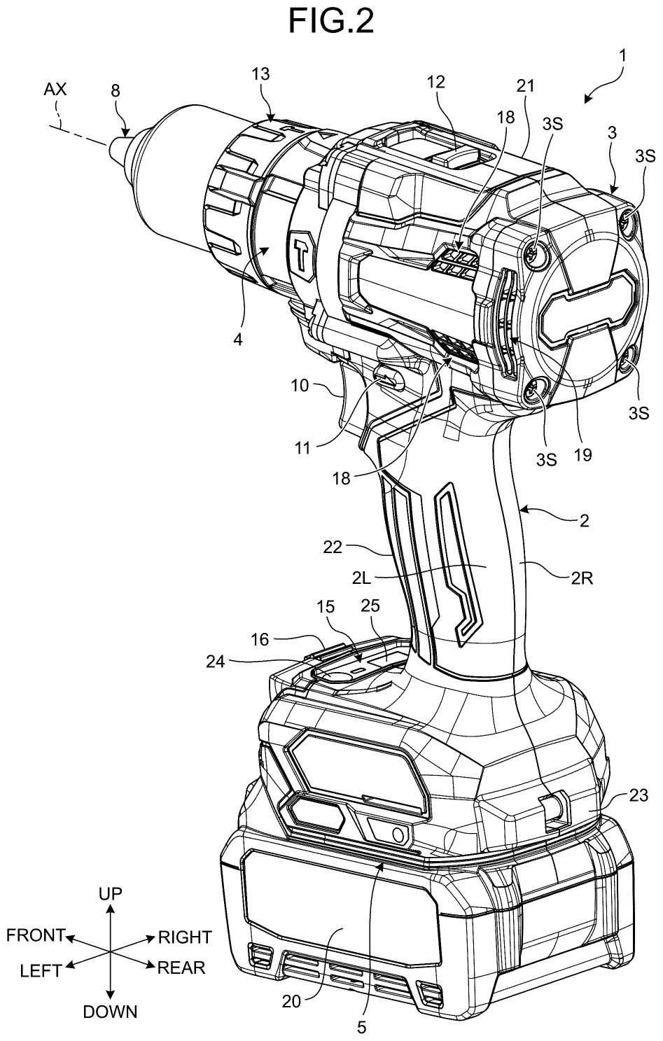

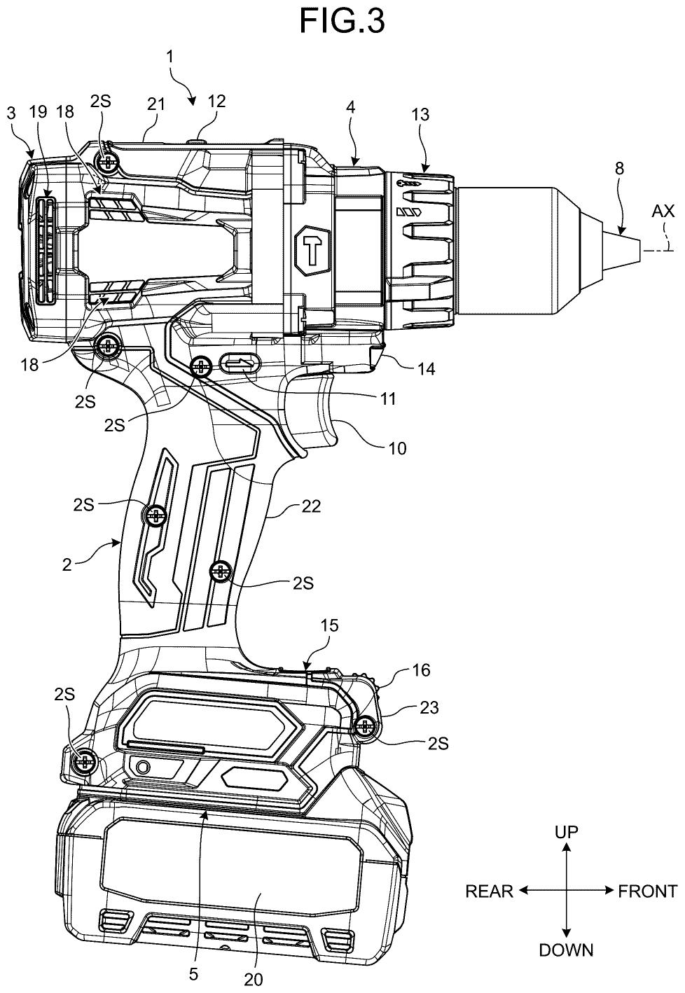

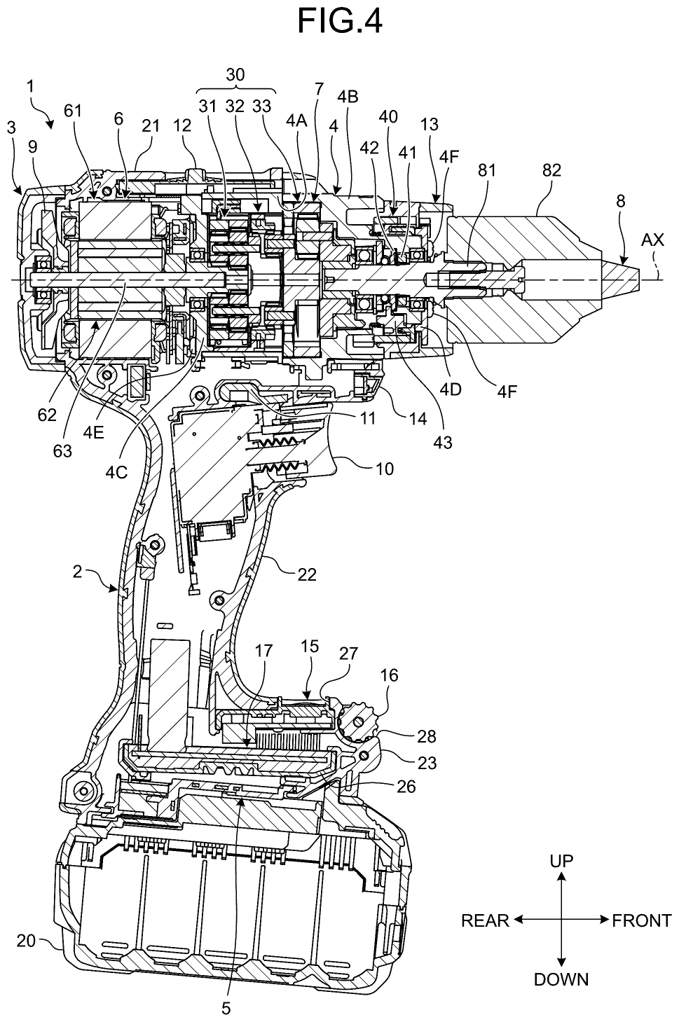

FIG. 1 is an oblique view, viewed from the front, that shows a driver-drill 1 according to the (first) embodiment. FIG. 2 is an oblique view, viewed from the rear, that shows the driver-drill 1 according to the embodiment. FIG. 3 is a side view that shows the driver-drill 1 according to the embodiment. FIG. 4 is a cross-sectional view that shows the driver-drill 1 according to the embodiment. In the (first) embodiment, the driver-drill 1 is a hammer driver-drill.

As shown in FIGS. 1-4, the driver-drill 1 comprises a housing 2, a rear cover 3, a casing 4, a battery-mounting part 5, a motor 6, a power-transmission mechanism 7, an output part 8, a fan 9, a trigger lever (trigger switch or simply trigger) 10, a forward/reverse-switch lever (reversing switch lever) 11, a speed change lever 12, an action mode changing ring 13, a light 14, an interface panel 15, a dial 16, and a controller 17.

The housing 2 is made of a synthetic resin (polymer). In the embodiment, the housing 2 is made of a nylon (a polyamide). The housing 2 includes a left housing 2L and a right housing 2R. The left housing 2L and the right housing 2R are fixed by the screws 2S. By fixing the left housing 2L and the right housing 2R to each other, the housing 2 is formed.

The housing 2 comprises a motor-housing part 21, a grip part 22, and a battery-holding part 23.

The motor-housing part 21 houses the motor 6. The motor-housing part 21 has a tubular shape. The motor-housing part 21 is disposed so as to cover the periphery of the motor 6.

The grip part 22 is configured to be gripped by the user. The grip part 22 is disposed downward of the motor-housing part 21. The grip part 22 extends downward from the motor-housing part 21. The trigger lever 10 is disposed at a front portion of the grip part 22.

The battery-holding part 23 houses the controller 17. The battery-holding part 23 is disposed at a lower portion of the grip part 22. The battery-holding part 23 is connected to a lower-end portion of the grip part 22. In both the front-rear direction and the left-right direction, the dimension of the outer shape of the battery-holding part 23 is larger than the dimension of the outer shape of the grip part 22.

The rear cover 3 is made of a synthetic resin (polymer), such as a polyamide. The rear cover 3 is disposed rearward of the motor-housing part 21. The rear cover 3 is disposed so as to cover a rear portion of the motor 6. The rear cover 3 houses the fan 9. The rear cover 3 is disposed so as to cover an opening in a rear portion of the motor-housing part 21. The rear cover 3 is fixed to the motor-housing part 21 by screws 3S.

In the embodiment, the motor-housing part 21 and the rear cover 3 are enclosing members that cover the periphery and a rear portion of the motor 6. It is noted that the motor-housing part 21 and the rear cover 3 may be integral with each other (i.e. formed in a unitary manner with no seams or breaks therebetween).

The motor-housing part 21 has air-intake ports 18. The rear cover 3 has air-exhaust ports 19. Air that exterior of the housing 2 flows into the interior space of the housing 2 via the air-intake ports 18. Air in the interior space of the housing 2 flows out to the exterior of the housing 2 via the air-exhaust ports 19.

The casing 4 houses the power-transmission mechanism 7. The casing 4 comprises a first casing 4A, a second casing 4B, a bracket plate 4C, and a stop plate 4D. The second casing 4B is disposed forward of the first casing 4A. The action mode changing ring 13 is disposed forward of the second casing 4B. The first casing 4A is made of a synthetic resin (polymer), such as a polyamide. The second casing 4B is made of a metal. In the embodiment, the second casing 4B is made of aluminum or an aluminum alloy. The casing 4 is connected to a front portion of the motor-housing part 21. Both the first casing 4A and the second casing 4B have a tubular shape.

The first casing 4A is fixed to a rear-end portion of the second casing 4B. The bracket plate 4C is disposed so as to cover an opening in a rear-end portion of the first casing 4A. The bracket plate 4C is fixed to a rear-end portion of the first casing 4A by screws 4E.

The stop plate 4D is disposed so as to cover an opening in a front-end portion of the second casing 4B. The stop plate 4D is fixed to the front-end portion of the second casing 4B by screws 4F.

The casing 4 is disposed so as to cover an opening in a front portion of the motor-housing part 21. The first casing 4A is disposed on the inner side of the motor-housing part 21. The second casing 4B is fixed to the motor-housing part 21 by screws 4S.

The battery-mounting part 5 is formed at a lower portion of the battery-holding part 23. The battery-mounting part 5 is physically and electrically connectable to the battery pack 20. The battery pack 20 is mounted on the battery-mounting part 5. The battery pack 20 is detachable from the battery-mounting part 5. The battery pack 20 comprises secondary batteries. In the embodiment, the battery pack 20 comprises rechargeable lithium-ion batteries, although the battery chemistry is not particularly limited and, e.g., solid-state rechargeable batteries may be used. When mounted on the battery-mounting part 5, the battery pack 20 can supply electric power to the driver-drill 1. The motor 6 is driven using electric power supplied from the battery pack 20. The interface panel 15 and the controller 17 operate using electric power supplied from the battery pack 20.

The motor 6 is the motive power supply of the driver-drill 1. The motor 6 is an inner-rotor-type brushless motor. The motor 6 is housed in the motor-housing part 21. The motor 6 comprises a stator 61, which has a tubular shape, and a rotor 62, which is disposed in the interior of the stator 61. The rotor 62 rotates relative to the stator 61. The rotor 62 comprises a rotor shaft 63, which extends in the axial direction.

The power-transmission mechanism 7 is disposed forward of the motor 6. The power-transmission mechanism 7 is housed in the casing 4. The power-transmission mechanism 7 couples the rotor shaft 63 and the output part 8 to each other. The power-transmission mechanism 7 transmits motive power generated by the motor 6 to the output part 8. The power-transmission mechanism 7 comprises a plurality of gears.

The power-transmission mechanism 7 comprises a speed-reducing mechanism 30 and a hammer (percussion) mechanism 40.

The speed-reducing mechanism 30 causes the output part 8 to rotate at a rotational speed that is lower than the rotational speed of the rotor 62 (rotor shaft 63) but at a higher torque. In the embodiment, the speed-reducing mechanism 30 comprises a first planetary-gear mechanism 31, a second planetary-gear mechanism 32, and a third planetary-gear mechanism 33. At least a portion of the first planetary-gear mechanism 31 is disposed more forward than the motor 6. The second planetary-gear mechanism 32 is disposed more forward than the first planetary-gear mechanism 31. The third planetary-gear mechanism 33 is disposed more forward than the second planetary-gear mechanism 32. The first planetary-gear mechanism 31 is driven by the rotational force of the motor 6. The second planetary-gear mechanism 32 is driven by the rotational force of the first planetary-gear mechanism 31. The third planetary-gear mechanism 33 is driven by the rotational force of the second planetary-gear mechanism 32.

The hammer mechanism 40 causes the output part 8 to hammer in the axial direction. The hammer mechanism 40 comprises a first cam 41, a second cam 42, and a hammer-change ring 43.

The output part 8 is disposed more forward than the motor 6. The output part 8 is rotated by the rotational force of the rotor 62. The output part 8 is rotated, in the state in which the tool accessory has been mounted, in response to application of the rotational force transmitted from the rotor 62 via the power-transmission mechanism 7. The output part 8 comprises: a spindle 81, which is rotated around rotational axis AX in response to application of the rotational force transmitted from the rotor 62; and a chuck 82, which is mounted on a front-end portion of the spindle 81. The tool accessory is held in (by) the chuck 82. A front-end portion of the chuck 82 is disposed more forward than the casing 4. At least a portion of the spindle 81 is disposed more forward than the third planetary-gear mechanism 33. The spindle 81 is coupled to the third planetary-gear mechanism 33. The spindle 81 is rotated by the rotational force of the rotor 62 transmitted via the first planetary-gear mechanism 31, the second planetary-gear mechanism 32, and the third planetary-gear mechanism 33.

The fan 9 is disposed rearward of the motor 6. The fan 9 generates an airflow for cooling the motor 6. The fan 9 is fixed to at least a portion of the rotor 62. The fan 9 is fixed to a rear portion of the rotor shaft 63. The fan 9 is rotated by the rotation of the rotor shaft 63. When the rotor shaft 63 rotates, the fan 9 is rotated together with the rotor shaft 63. When the fan 9 rotates, air that is outside of the housing 2 flows into the interior space of the housing 2 via the air-intake ports 18. The air that has flowed into the interior space of the housing 2 flows through the interior space of the housing 2, and thereby cools the motor 6. The air that has flowed through the interior space of the housing 2 flows out to the exterior of the housing 2 via the air-exhaust ports 19.

The trigger lever 10 is manipulated (squeezed, pulled) to start the motor 6. The trigger lever 10 is provided at an upper portion of the grip part 22. A front-end portion of the trigger lever 10 protrudes forward from a front portion of the grip part 22. The trigger lever 10 is movable in the front-rear direction. The trigger lever 10 is manipulated by the user. By manipulating the trigger lever 10 such that it moves rearward, the motor 6 starts. By releasing the manipulation of the trigger lever 10, the motor 6 stops.

The forward/reverse-switch lever 11 is manipulated (pressed, slid) to switch the rotational direction of the motor 6. The forward/reverse-switch lever 11 is provided at an upper portion of the grip part 22. A left-end portion of the forward/reverse-switch lever 11 protrudes leftward from a left portion of the grip part 22. A right-end portion of the forward/reverse-switch lever 11 protrudes rightward from a right portion of the grip part 22. The forward/reverse-switch lever 11 is movable in the left-right direction. The forward/reverse-switch lever 11 is manipulated by the user. By manipulating the forward/reverse-switch lever 11 such that it moves leftward, the rotor 62 of the motor 6 is rotated in the forward-rotational direction. By manipulating the forward/reverse-switch lever 11 such that it moves rightward, the rotor 62 of the motor 6 is rotated in the reverse-rotational direction. By changing the rotational direction of the motor 6, the rotational direction of the spindle 81 switches.

The speed change lever 12 is manipulated (slid) to change the speed mode (variable-speed stage) of the speed-reducing mechanism 30. The speed change lever 12 is provided at (on) an upper portion of the motor-housing part 21. The speed change lever 12 is movable in the front-rear direction. The speed change lever 12 is manipulated by the user. The speed modes (variable-speed stages) of the speed-reducing mechanism 30 include a low-speed mode (speed “1”), a medium-speed mode (speed “2”), and a high-speed mode (speed “3”). That is, in the embodiment, the number of variable-speed stages of the speed-reducing mechanism 30 is three. Thus, the speed-reducing mechanism 30 is a three-stage, variable-speed, speed-reducing mechanism.

The low-speed mode refers to a speed mode in which the output part 8 is caused to rotate at a first rotational speed (low speed) in the state in which the rotor 62 is rotating at a given rotational speed. The medium-speed mode refers to a speed mode in which the output part 8 is caused to rotate at a second rotational speed (medium speed), which is higher than the first rotational speed (but at a lower torque), in the state in which the rotor 62 is rotating at the given rotational speed. The high-speed mode refers to a speed mode in which the output part 8 is caused to rotate at a third rotational speed (high speed), which is higher than the second rotational speed (but at a lower torque), in the state in which the rotor 62 is rotating at the given rotational speed. The movable range of the speed change lever 12 is defined in the front-rear direction. By manipulating (sliding) the speed change lever 12 such that it moves to a front portion of the movable range, the speed mode of the speed-reducing mechanism 30 is set to the low-speed mode. By manipulating (sliding) the speed change lever 12 such that it moves to an intermediate portion of the movable range, the speed mode of the speed-reducing mechanism 30 is set to the medium-speed mode. By manipulating (sliding) the speed change lever 12 such that it moves to a rear portion of the movable range, the speed mode of the speed-reducing mechanism 30 is set to the high-speed mode.

The action mode changing ring 13 is manipulated (rotated) to change the action mode of the hammer mechanism 40. The action mode changing ring 13 is disposed forward of the casing 4. The action mode changing ring 13 is rotatable. The action mode changing ring 13 is manipulated by the user. The action modes of the hammer mechanism 40 include a hammering mode and a non-hammering mode. The hammering mode refers to an action mode in which the output part 8 is caused to hammer (linearly reciprocate) in the axial direction. The non-hammering mode refers to an action mode in which the output part 8 is not caused to hammer in the axial direction. By manipulating (rotating) the action mode changing ring 13 such that it is disposed at the hammer-mode position in the rotational direction, the action mode of the hammer mechanism 40 is set to the hammering mode. By manipulating (rotating) the action mode changing ring 13 such that it is disposed at the non-hammer-mode position in the rotational direction, the action mode of the hammer mechanism 40 is set to the non-hammering mode.

The light 14 emits illumination light that illuminates forward of the driver-drill 1. The light 14 comprises, for example, one or more light-emitting diodes (LED(s)). The light 14 is disposed at a lower portion of a front portion of the motor-housing part 21. The light 14 is disposed upward of the trigger lever 10.

The interface panel 15 is provided on the battery-holding part 23. The interface panel 15 comprises a manipulation device 24 and a display device 25. The interface panel 15 has a sheet shape. The manipulation device 24 comprises at least one manipulatable button. Illustrative examples of the display device 25 are: a segmented-display device, which comprises a plurality of segment, light-emitting devices; a flat-panel display, such as a liquid-crystal display; and an indicator-type display device, on which a plurality of light-emitting diodes are disposed.

A panel opening 27 is formed in the battery-holding part 23. The panel opening 27 is formed in an upper surface of the battery-holding part 23 more forward than the grip part 22. At least a portion of the interface panel 15 is disposed in the panel opening 27.

The manipulation device 24 is manipulated (pressed) to change the action (drive) mode of the motor 6. The manipulation device 24 is manipulated by the user. The action (drive) modes of the motor 6 include a drilling mode and a screwdriving (clutch) mode. The drilling mode refers to a drive mode (action mode) in which, during the drive of the motor 6, the motor 6 is driven regardless of the torque that is acting on the motor 6 (output part 8). The screwdriving mode refers to a drive mode (action mode) in which, during the drive of the motor 6, the motor 6 is stopped when the momentary currently being supplied to the motor 6 exceeds an electric-current threshold (i.e. the torque that is acting on the output part 8 exceeds a torque threshold set using the dial 16, as will be explained below).

The dial 16 is manipulated (rotated) to change the drive condition of the motor 6. The dial 16 is disposed at a front portion of the battery-holding part 23. The dial 16 is supported on the battery-holding part 23 in a rotatable manner. The dial 16 is rotatable over a range of 360° or more, i.e. the dial 16 is preferably endlessly rotatable. The dial 16 is manipulated by the user. The drive conditions of the motor 6 include the electric-current threshold, which is proportional to the torque being applied to the output part 8. The dial 16 is manipulated to change the electric-current threshold (i.e. the maximum output torque value) in the screwdriving mode, which had been set by (using) the manipulation device 24.

A dial opening 28 is formed in the battery-holding part 23. The dial opening 28 is formed in a right portion of a front portion of the battery-holding part 23. At least a portion of the dial 16 is disposed in the dial opening 28.

The controller 17 comprises a computer system. The controller 17 outputs control instructions to control the motor 6. At least a portion of the controller 17 is housed in a controller case 26. In the state in which the controller 17 is held by the controller case 26, the controller 17 is housed in the battery-holding part 23. The controller 17 comprises a circuit board, on which a plurality of electronic parts is mounted. Illustrative examples of the electronic parts mounted on the circuit board include: a processor, such as a CPU (central-processing unit); nonvolatile memory, such as ROM (read-only memory) and storage; volatile memory, such as RAM (random-access memory); transistors; capacitors; and resistors.

The controller 17 sets the drive conditions of the motor 6 in response to the manipulation (rotation) of the dial 16. As described above, the drive conditions of the motor 6 include the electric-current threshold, which corresponds to the maximum torque applied by the output part 8 to the tool accessory. In the screwdriving mode, the controller 17 sets the electric-current threshold in response to the manipulation of the dial 16.

In addition, in the screwdriving mode, the controller 17 stops the motor 6 when the torque that acts on the motor 6 (output part 8) during the drive of the motor 6 exceeds the electric-current threshold.

In addition, the controller 17 displays the set drive condition of the motor 6 on the display device 25.

### Motor and Power-Transmission Mechanism

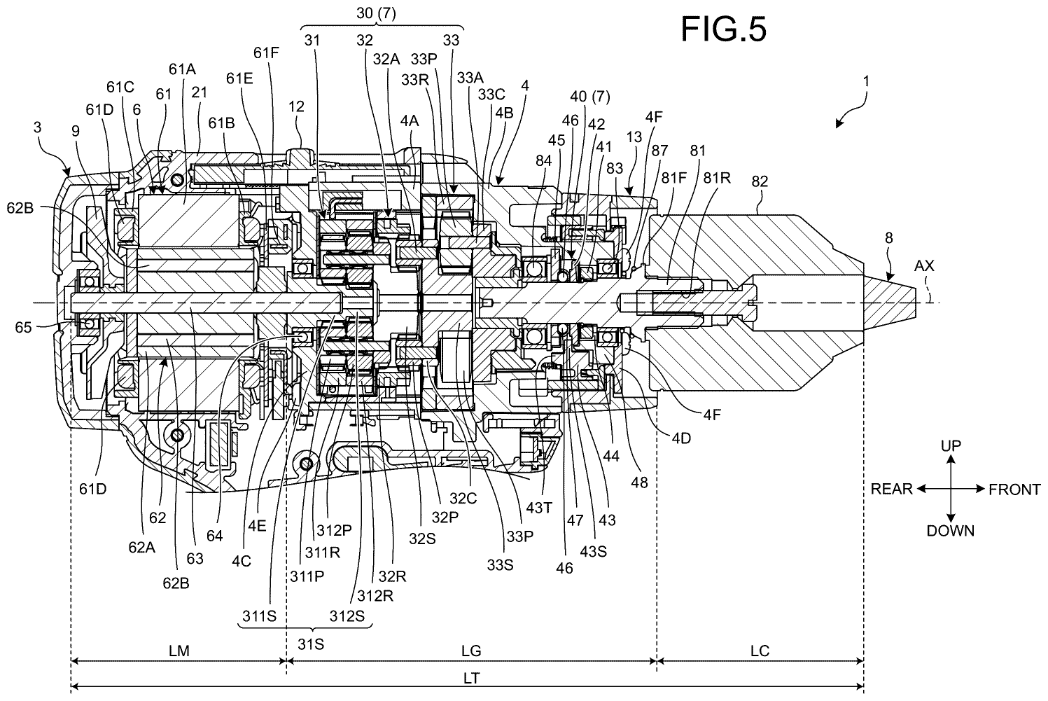

FIG. 5 is a cross-sectional view that shows an upper portion of the driver-drill 1 according to the embodiment. As shown in FIG. 5, the motor 6 comprises: the stator 61, which has a tubular shape; and the rotor 62, which is disposed in the interior of the stator 61. The rotor 62 comprises the rotor shaft 63, which extends in the axial direction.

The stator 61 comprises: a stator core 61A, which comprises a plurality of stacked (laminated) steel sheets; a front insulator 61B, which is disposed at a front portion of the stator core 61A; a rear insulator 61C, which is disposed at a rear portion of the stator core 61A; a plurality of coils 61D, which are wound around respective teeth of the stator core 61A and over (around) the front insulator 61B and the rear insulator 61C; a sensor circuit board 61E, which is mounted on the front insulator 61B; and a short-circuiting member (busbar) 61F, which is supported on the front insulator 61B. The sensor circuit board 61E comprises a plurality of rotation-detection devices, which detects the rotation of the rotor 62. The short-circuiting member 61F connects the plurality of coils 61D via fusing terminals. The short-circuiting member 61F is connected to the controller 17 via lead lines.

The rotor 62 rotates around rotational axis AX. The rotor 62 comprises: the rotor shaft 63; a rotor core 62A, which is disposed around the rotor shaft 63; and a plurality of permanent magnets 62B, which are held on (in) the rotor core 62A. The rotor core 62A has a circular-tube shape. The rotor core 62A comprises a plurality of stacked (laminated) steel sheets. The rotor core 62A has through holes, which extend in the axial direction. The through holes are disposed equispaced around the circumferential direction. The permanent magnets 62B are respectively disposed (embedded) in the plurality of through holes of the rotor core 62A.

The rotation-detection devices of the sensor circuit board 61E detect the rotation of the rotor 62 by detecting the magnetic fields of the permanent magnets 62B. The controller 17 supplies drive currents to the coils 61D based on the detection data from the rotation-detection devices.

The rotor shaft 63 rotates around rotational axis AX. Rotational axis AX of the rotor shaft 63 coincides with the rotational axis of the output part 8. A front portion of the rotor shaft 63 is supported by a (first) bearing 64 in a rotatable manner. A rear portion of the rotor shaft 63 is supported by a (second) bearing 65 in a rotatable manner. The bearing 64 is held by the bracket plate 4C, which is disposed forward of the stator 61. The bearing 65 is held by the rear cover 3. A front-end portion of the rotor shaft 63 is disposed more forward than the bearing 64. A front-end portion of the rotor shaft 63 is disposed in the interior space of the casing 4.

A pinion gear 31S is provided at a front-end portion of the rotor shaft 63. The pinion gear 31S functions as the sun gear of the first planetary-gear mechanism 31. The pinion gear 31S is rotated by the motor 6. The pinion gear 31S includes a large-diameter portion 311S and a small-diameter portion 312S, which is disposed more forward than the large-diameter portion 311S. The rotor shaft 63 is coupled to the first planetary-gear mechanism 31 of the speed-reducing mechanism 30 via the pinion gear 31S.

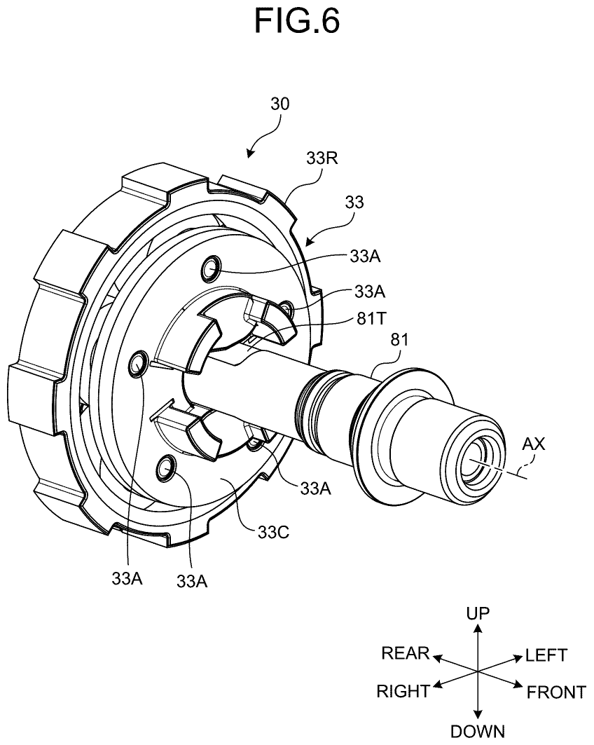

FIG. 6 is an oblique view, viewed from the right front, that shows a portion of the speed-reducing mechanism 30 according to the embodiment. The spindle 81 is coupled to a third carrier 33C. In the embodiment, a pair of flat surfaces 81T is formed on an outer-circumferential surface of the spindle 81. The flat surfaces 81T are parallel to rotational axis AX. The pair of flat surfaces 81T face each other in opposite directions. The third carrier 33C is disposed around the spindle 81. An inner-circumferential surface of the third carrier 33C includes support surfaces, which respectively make contact with the pair of flat surfaces 81T. Relative rotation between the third carrier 33C and the spindle 81 is constrained (blocked, prevented) by the flat surfaces 81T. When the third carrier 33C rotates, the spindle 81 is rotated together with the third carrier 33C.

In the embodiment, the outer diameter of the spindle 81, which is disposed in the interior of the third carrier 33C, is 10 mm. The distance between the flat surfaces 81T is 7.3 mm. Thereby, the spindle 81, which has high strength and is adapted to making the output part 8 high torque, is provided. That is, deterioration of the spindle 81 is curtailed even though the output part 8 is made to be high torque. Deterioration of the spindle 81 includes the occurrence of a crack or cracks in at least a portion of the spindle 81.

It is noted that the outer diameter of the spindle 81 can be made even thicker to deliver an even larger fastening torque. That is, the outer diameter of the spindle 81 can be made to be 12 mm. Furthermore, the outer diameter of the spindle 81 can further be made to be 14 mm. The upper limit value of the outer diameter of the spindle 81 is 16 mm. In accordance with the fastening torque, the outer diameter of the spindle 81 can be made to be between 10 mm or more and 16 mm or less. Between these values, a suitable value and range can be arbitrarily selected.

Furthermore, the distance between the flat surfaces 81T also can be made large. That is, the distance between the flat surfaces 81T can be made to be 9 mm. Furthermore, the distance between the flat surfaces 81T can be made to be 11 mm. The upper limit value of the distance between the flat surfaces 81T is 13 mm. The distance between the flat surfaces 81T can be made to be between 7.3 mm or more and 13 mm or less. Between these values, a suitable value and range can be arbitrarily selected.

The spindle 81 is supported by a (first) bearing 83 and a (second) bearing 84 in a rotatable manner. In the state in which the spindle 81 is supported by the bearing 83 and the bearing 84, the spindle 81 is movable in the front-rear direction.

The spindle 81 has a flange portion 81F. A coil spring 87 is disposed between the flange portion 81F and the bearing 83. The flange portion 81F makes contact with a front-end portion of the coil spring 87. The coil spring 87 generates an elastic force that moves (urges) the spindle 81 forward.

The chuck 82 is capable of holding a tool accessory. The chuck 82 is coupled to a front portion of the spindle 81. A screw hole 81R is provided at (in) a front-end portion of the spindle 81. The chuck 82 is rotated by the spindle 81. The chuck 82 rotates in the state in which the chuck 82 holds the tool accessory.

The first cam 41 and the second cam 42 of the hammer mechanism 40 are both disposed in the interior of the second casing 4B. In the front-rear direction, both the first cam 41 and the second cam 42 are disposed between the bearing 83 and the bearing 84.

The first cam 41 has a ring shape. The first cam 41 is disposed around the spindle 81. The first cam 41 is fixed to the spindle 81. The first cam 41 rotates together with the spindle 81. A cam gear is provided on a rear surface of the first cam 41. The first cam 41 is supported by a stop ring 44. The stop ring 44 is disposed around the spindle 81. In the front-rear direction, the stop ring 44 is disposed between the first cam 41 and the bearing 83.

The second cam 42 has a ring shape. The second cam 42 is disposed rearward of the first cam 41. The second cam 42 is disposed around the spindle 81. The second cam 42 is rotatable relative to the spindle 81. A cam gear is provided on a front surface of the second cam 42. The cam gear on the front surface of the second cam 42 meshes with the cam gear on the rear surface of the first cam 41. A tab is provided on a rear surface of the second cam 42.

In the front-rear direction, a support ring 45 is disposed between the second cam 42 and the bearing 84. The support ring 45 is disposed in the interior of the second casing 4B. The support ring 45 is fixed to the second casing 4B. A plurality of steel balls 46 is disposed on a front surface of the support ring 45. A washer 47 is disposed between the steel balls 46 and the second cam 42. The second cam 42 is rotatable in the state in which forward-rearward movement is restricted in the space defined by the support ring 45 and the washer 47.

The hammer-change ring 43 is changeable (switchable) between the hammering mode and the non-hammering mode. The action mode changing ring 13 is coupled to the hammer-change ring 43 via a cam ring 48. The action mode changing ring 13 and the cam ring 48 are integrally rotatable. The hammer-change ring 43 is movable in the front-rear direction. The hammer-change ring 43 has a projection portion 43T. The projection portion 43T is inserted into a guide hole, which is provided in the second casing 4B. The hammer-change ring 43 is movable in the front-rear direction while being guided by the guide hole provided in the second casing 4B. Rotation of the hammer-change ring 43 is restricted by the projection portion 43T. When the user manipulates (rotates) the action mode changing ring 13, the hammer-change ring 43 moves in the front-rear direction. By moving the hammer-change ring 43 in the front-rear direction between an advanced position and a retracted position, which is more rearward than the advanced position, the action mode changes between the hammering mode and the non-hammering mode. That is, by the manipulating of the action mode changing ring 13, the action mode changes between the hammering mode and the non-hammering mode.

The hammering mode includes the state in which rotation of the second cam 42 is restricted (blocked). The non-hammering mode includes the state in which rotation of the second cam 42 is permitted. When the hammer-change ring 43 moves to the advanced position, rotation of the second cam 42 is restricted (blocked). When the hammer-change ring 43 moves to the retracted position, rotation of the second cam 42 is permitted.

In the hammering mode, at least a portion of the hammer-change ring 43, which has moved to the advanced position, makes contact with the second cam 42. When the hammer-change ring 43 and the second cam 42 contact each other, rotation of the second cam 42 is restricted (blocked). In the state in which rotation of the second cam 42 is restricted (blocked), when the motor 6 is driven, the first cam 41, which is fixed to the spindle 81, rotates while making contact with the cam gear of the second cam 42. Thereby, the spindle 81 is rotated while hammering in the front-rear direction.

In the non-hammering mode, the hammer-change ring 43, which has moved to the retracted position, is spaced apart from the second cam 42. Owing to the hammer-change ring 43 being spaced apart from the second cam 42, rotation of the second cam 42 is permitted. In the state in which rotation of the second cam 42 is permitted, when the motor 6 is driven, the second cam 42 rotates together with the first cam 41 and the spindle 81. Thereby, the spindle 81 is rotated without hammering in the front-rear direction.

The hammer-change ring 43 is disposed around the first cam 41 and the second cam 42. In addition, the hammer-change ring 43 comprises an opposing portion 43S, which opposes a rear surface of the second cam 42. The opposing portion 43S protrudes radially inward from a rear portion of the hammer-change ring 43.

When the action mode changing ring 13 is manipulated (rotated) and the hammer-change ring 43 moves to the advanced position, the tab on the rear surface of the second cam 42 and the opposing portion 43S of the hammer-change ring 43 make contact with each other. Thereby, rotation of the second cam 42 is restricted (blocked). Thus, owing to the action mode changing ring 13 being manipulated and the hammer-change ring 43 moving to the advanced position, the hammer mechanism 40 changes to the hammering mode.

When the action mode changing ring 13 is manipulated (rotated) and the hammer-change ring 43 moves to the retracted position, the opposing portion 43S of the hammer-change ring 43 is spaced apart from the second cam 42. Thereby, rotation of the second cam 42 is permitted. Thus, owing to the action mode changing ring 13 being manipulated and the hammer-change ring 43 moving to the retracted position, the hammer mechanism 40 changes to the non-hammering mode.

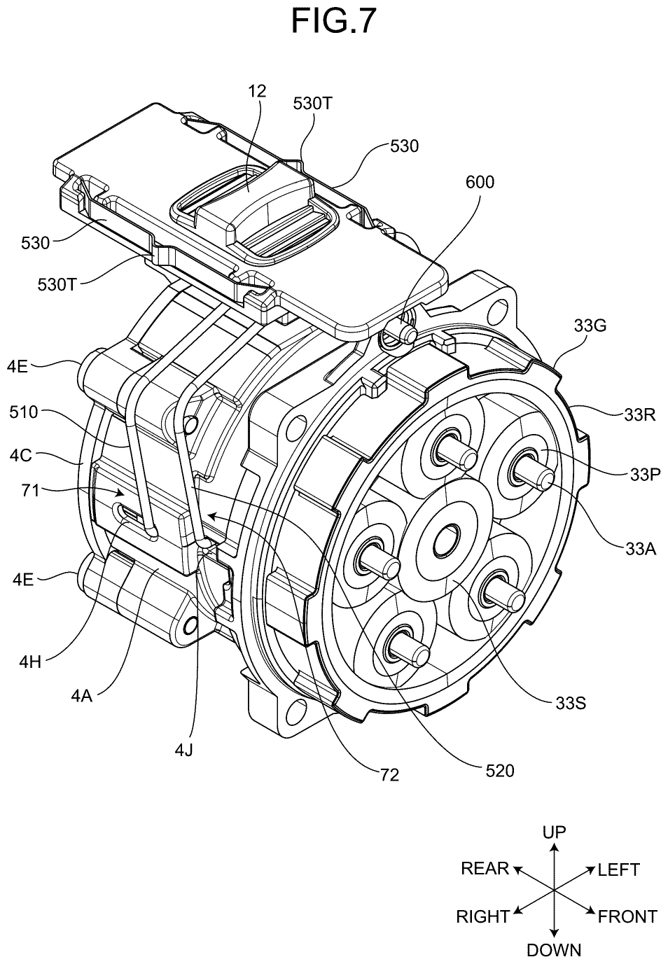

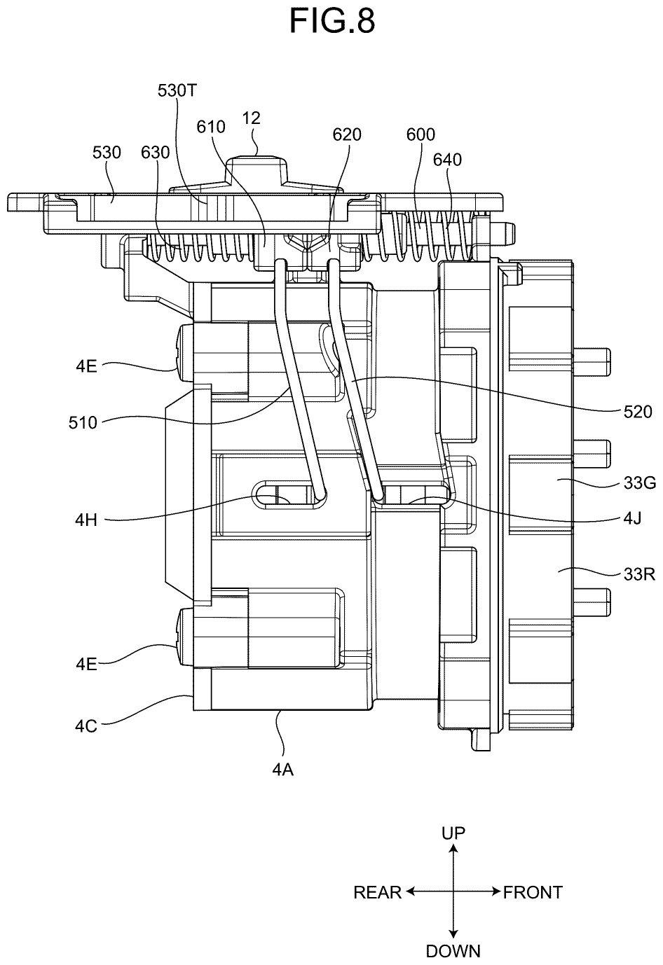

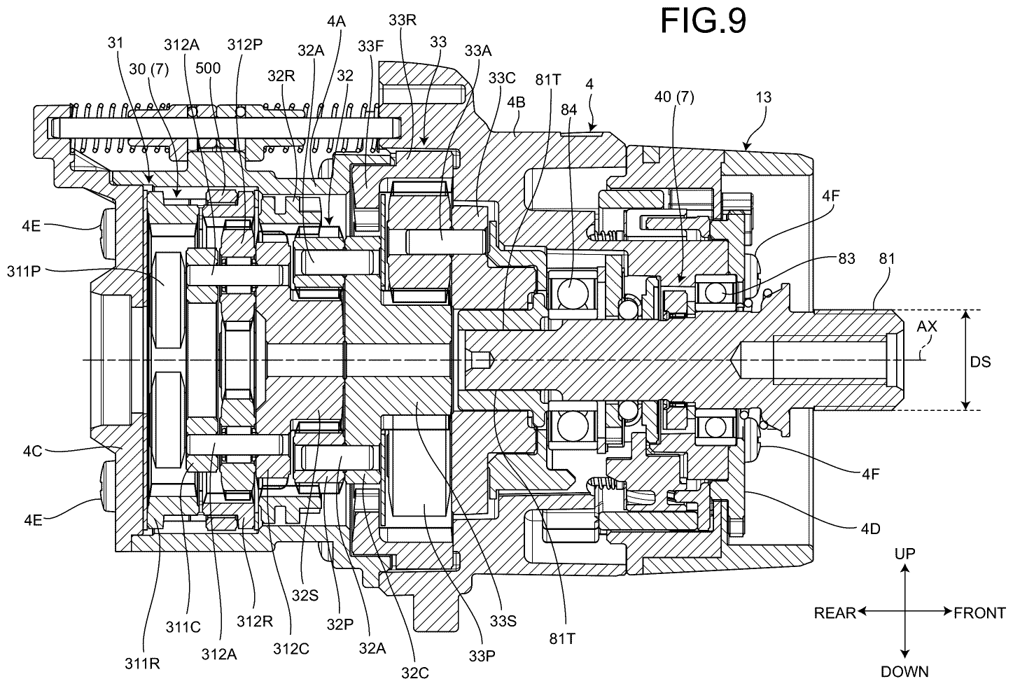

FIG. 7 is an oblique view, viewed from the front, that shows a portion of the driver-drill 1 according to the embodiment. FIG. 8 is a side view that shows a portion of the driver-drill 1 according to the embodiment. FIG. 9 is a cross-sectional view that shows a portion of the driver-drill 1 according to the embodiment.

The speed change lever 12 is manipulated (slid) to change the speed mode of the speed-reducing mechanism 30. The speed change lever 12 is provided upward of the casing 4. The speed change lever 12 is movable (slidable) in the front-rear direction. The speed change lever 12 is configured to be manipulated by the user. The speed modes of the speed-reducing mechanism 30 include the low-speed mode (speed “1”), the medium-speed mode (speed “2”), and the high-speed mode (speed “3”). By manipulating (sliding) the speed change lever 12 such that it moves to a front portion of the movable range, the speed mode of the speed-reducing mechanism 30 is set to the low-speed mode (speed “1”). By manipulating (sliding) the speed change lever 12 such that it moves to an intermediate portion of the movable range, the speed mode of the speed-reducing mechanism 30 is set to the medium-speed mode (speed “2”). By manipulating (sliding) the speed change lever 12 such that it moves to a rear portion of the movable range, the speed mode of the speed-reducing mechanism 30 is set to the high-speed mode (speed “3”).

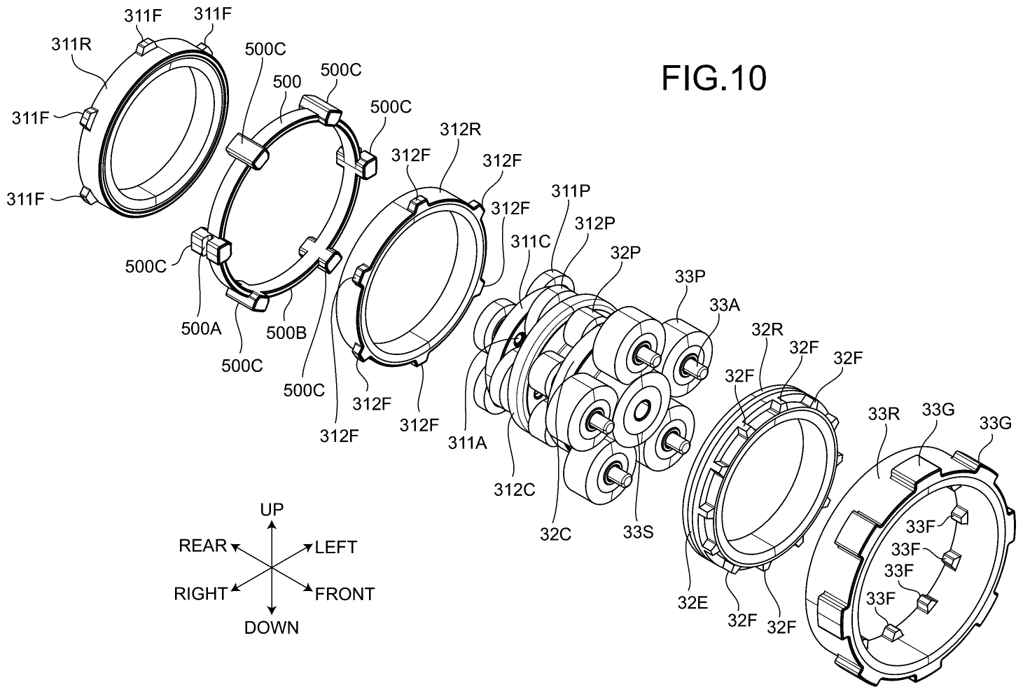

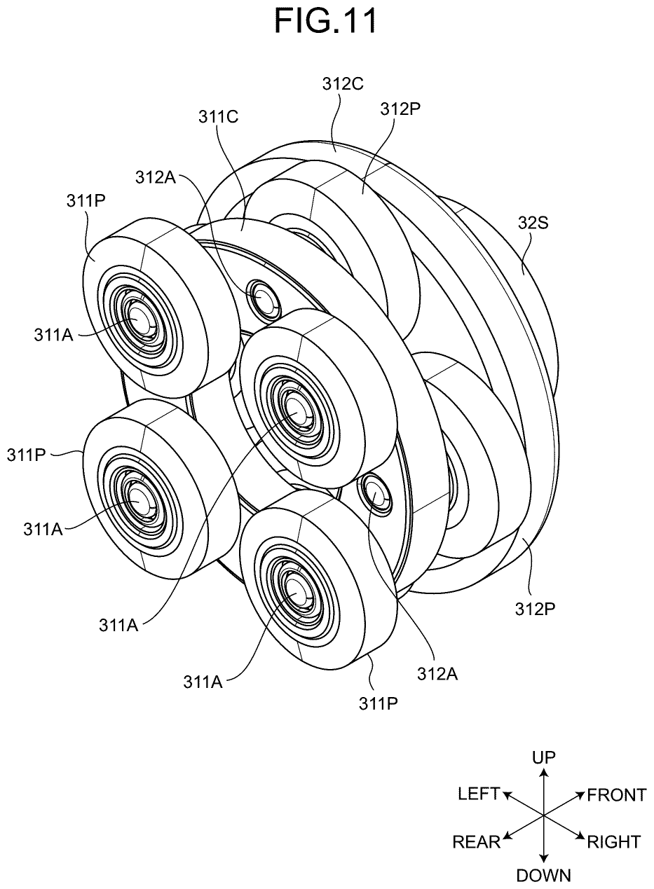

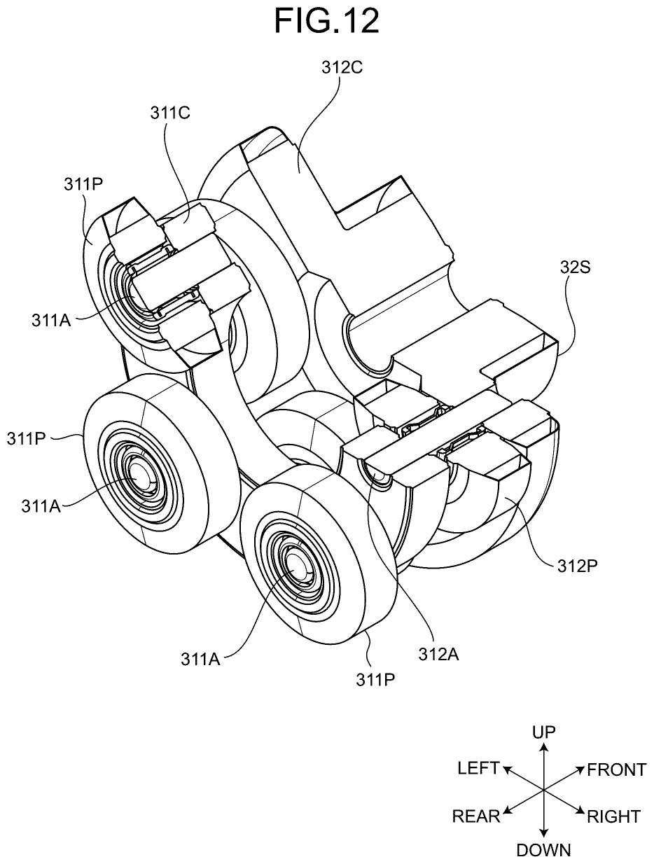

FIG. 10 is an exploded, oblique view, viewed from the front, that shows the speed-reducing mechanism 30 according to the embodiment. FIG. 11 is an oblique view, viewed from the rear, that shows a portion of the speed-reducing mechanism 30 according to the embodiment. FIG. 12 is an oblique, broken view, viewed from the rear, that shows a portion of the speed-reducing mechanism 30 according to the embodiment.

The first planetary-gear mechanism 31 comprises: planet gears 311P (first planet gears); planet gears 312P (second planet gears), which are disposed more forward than the planet gears 311P; a first-stage carrier 311C, which supports both the plurality of planet gears 311P and the plurality of planet gears 312P; a second-stage carrier 312C, which supports the plurality of planet gears 312P; an internal gear 311R, which is disposed around the plurality of planet gears 311P; and an internal gear 312R, which is disposed around the plurality of planet gears 312P. As shown in FIG. 5, the pinion gear 31S is provided at a front-end portion of the rotor shaft 63. The pinion gear 31S functions as the sun gear of the first planetary-gear mechanism 31. The pinion gear 31S is disposed forward of the stator 61. The pinion gear 31S is rotated by the rotor 62. The pinion gear 31S may be rotated directly by the rotor 62 or may be rotated indirectly.

The second planetary-gear mechanism 32 comprises: a sun gear 32S; a plurality of planet gears 32P, which are disposed around the sun gear 32S; a second carrier 32C, which supports the plurality of planet gears 32P; and an internal gear 32R, which is disposed around the plurality of planet gears 32P. The sun gear 32S is disposed forward of the internal gear 311R and the internal gear 312R. The sun gear 32S may be rotated directly by the planet gears 311P and the planet gears 312P or may be rotated indirectly. The planet gears 32P mesh with the sun gear 32S. The internal gear 32R meshes with the planet gears 32P.

The third planetary-gear mechanism 33 comprises: a sun gear 33S; a plurality of planet gears 33P, which are disposed around the sun gear 33S; the third carrier 33C, which supports the plurality of planet gears 33P; and an internal gear 33R, which is disposed around the plurality of planet gears 33P.

The plurality of planet gears 311P is disposed around the large-diameter portion 311S of the pinion gear 31S. The plurality of planet gears 312P is disposed around the small-diameter portion 312S of the pinion gear 31S.

The casing 4 is disposed forward of the stator 61. The casing 4 houses the pinion gear 31S, the planet gears 311P, the planet gears 312P, the internal gear 311R, the internal gear 312R, the sun gear 32S, and the planet gears 32P. The spindle 81 is disposed forward of the internal gear 32R. The spindle 81 may be rotated directly by the planet gears 32P or may be rotated indirectly. The chuck 82 is fixed to a front portion of the spindle 81.

The planet gears 311P are respectively supported on first pins 311A in a rotatable manner. The first pins 311A are supported on the first-stage carrier 311C. The first pins 311A protrude rearward from a rear surface of the first-stage carrier 311C. The first pins 311A are provided spaced apart in the circumferential direction. In the embodiment, four of the first pins 311A are provided equispaced in the circumferential direction. One planet gear 311P is supported on each first pin 311A of the plurality of (four) first pins 311A. The planet gears 311P are disposed more rearward than the first-stage carrier 311C. The first-stage carrier 311C rotatably supports the planet gears 311P on the first pins 311A.

The planet gears 312P are respectively supported on second pins 312A in a rotatable manner. The second pins 312A are supported on both the first-stage carrier 311C and the second-stage carrier 312C. The first-stage carrier 311C is disposed more rearward than the second-stage carrier 312C. A rear-end portion of each of the second pins 312A is supported on the first-stage carrier 311C. A front-end portion of each of the second pins 312A is supported on the second-stage carrier 312C. The second pins 312A are provided spaced apart in the circumferential direction. In the embodiment, four of the second pins 312A are provided equispaced in the circumferential direction. In the circumferential direction, the locations of the first pins 311A and the locations of the second pins 312A differ from each other. In the circumferential direction, each of the second pins 312A is disposed between a pair of the first pins 311A that are adjacent to each other. One planet gear 312P is supported on cach second pin 312A of the plurality of (four) second pins 312A. In the front-rear direction (axial direction), the planet gears 312P are disposed between the first-stage carrier 311C and the second-stage carrier 312C. The first-stage carrier 311C and the second-stage carrier 312C support the planet gears 312P in a rotatable manner via the second pins 312A. A gear is provided on an outer-circumferential portion of the second-stage carrier 312C.

The internal gear 311R (first internal gear) is disposed around the plurality of planet gears 311P. The internal gear 312R (second internal gear) is disposed around the plurality of planet gears 312P. The outer diameter of the planet gears 311P is smaller than the outer diameter of the planet gears 312P.

The second planetary-gear mechanism 32 comprises: the sun gear 32S; the plurality of planet gears 32P, which are disposed around the sun gear 32S; the second carrier 32C, which supports the plurality of planet gears 32P; and the internal gear 32R, which is disposed around the plurality of planet gears 32P. The sun gear 32S is disposed forward of the second-stage carrier 312C. The diameter of the sun gear 32S is smaller than the diameter of the second-stage carrier 312C. The second-stage carrier 312C and the sun gear 32S are integral with each other. The second-stage carrier 312C and the sun gear 32S rotate together. Pins 32A are provided on the second carrier 32C. The planet gears 32P are respectively supported on the pins 32A in a rotatable manner. The second carrier 32C rotatably supports the planet gears 32P on the pins 32A.

The third planetary-gear mechanism 33 comprises: the sun gear 33S; the plurality of planet gears 33P, which are disposed around the sun gear 33S; the third carrier 33C, which supports the plurality of planet gears 33P; and the internal gear 33R, which is disposed around the plurality of planet gears 33P. The sun gear 33S is disposed forward of the second carrier 32C. The diameter of the sun gear 33S is smaller than the diameter of the second carrier 32C. The second carrier 32C and the sun gear 33S are integral with each other. The second carrier 32C and the sun gear 33S rotate together. Pins 33A are provided on the third carrier 33C. The planet gears 33P are respectively supported on the pins 33A in a rotatable manner. The third carrier 33C rotatably supports the planet gears 33P on the pins 33A.

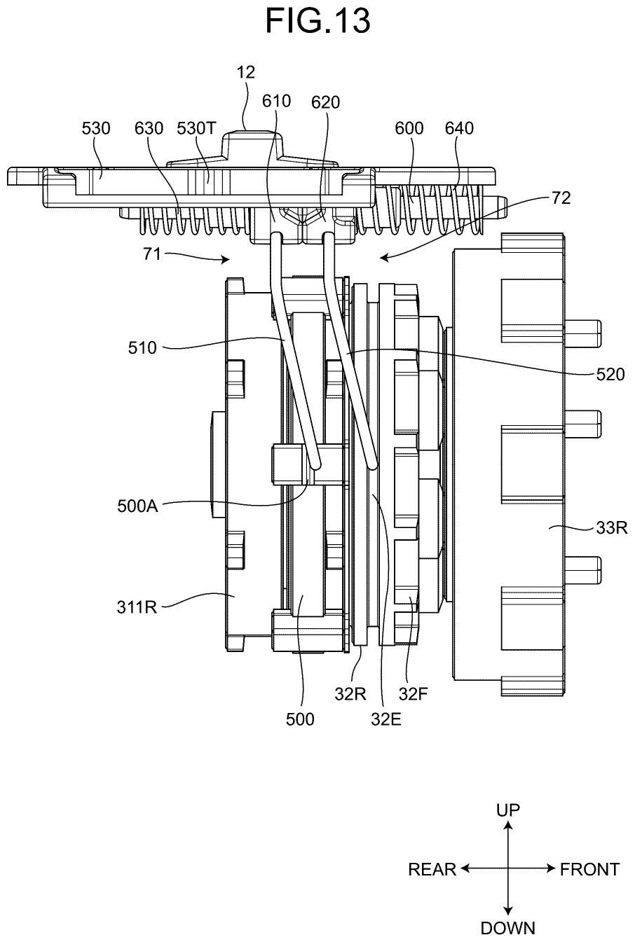

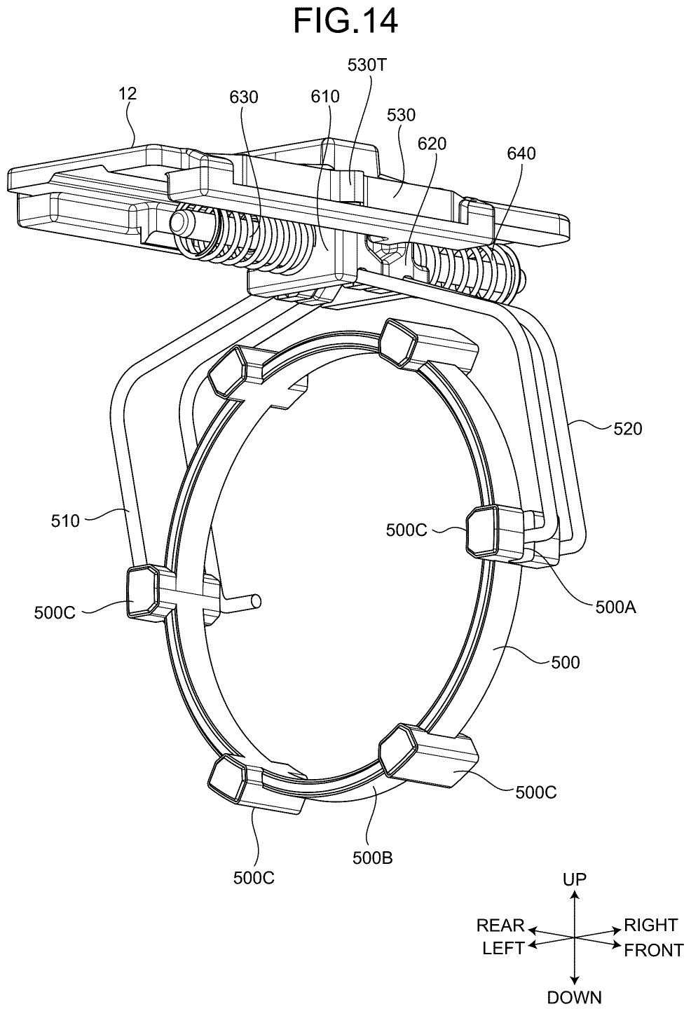

FIG. 13 is a side view that shows a first speed-changing mechanism 71 and a second speed-changing mechanism 72 according to the embodiment. FIG. 14 is an oblique view, viewed from the lower-right rear, that shows the first speed-changing mechanism 71 and the second speed-changing mechanism 72 according to the embodiment. The speed-reducing mechanism 30 comprises the first speed-changing mechanism 71 and the second speed-changing mechanism 72.

The first speed-changing mechanism 71 changes between: a first speed-reducing mode, in which rotation of the internal gear 312R of the first planetary-gear mechanism 31 is blocked and rotation of the internal gear 311R is permitted; and a second speed-reducing mode, in which rotation of the internal gear 311R of the first planetary-gear mechanism 31 is blocked and rotation of the internal gear 312R is permitted.

The first speed-changing mechanism 71 comprises a change ring 500, a first change wire 510, a first movable member 610, and a first spring 630.

The change ring 500 comprises a ring portion 500B and a plurality of protruding portions 500C, which are fixed to the ring portion 500B. The protruding portions 500C are disposed in guide grooves, which are provided in the inner-circumferential surface of the first casing 4A. The guide grooves provided in the inner-circumferential surface of the first casing 4A extend in the front-rear direction. By disposing the protruding portions 500C in the guide grooves of the first casing 4A, rotation of the change ring 500 relative to the first casing 4A is constrained (blocked, prevented). The change ring 500 is movable in the front-rear direction in the interior of the first casing 4A. The change ring 500 can move in the front-rear direction while being guided in the guide grooves provided in the inner-circumferential surface of the first casing 4A. The change ring 500 is disposed around at least one of the internal gear 311R and the internal gear 312R.

The change ring 500 is coupled to the first change wire 510. The change ring 500 is movable in the front-rear direction in the interior of the first casing 4A. By moving the change ring 500 forward, the mode becomes the first speed-reducing mode; by moving the change ring 500 rearward, the mode becomes the second speed-reducing mode.

In the embodiment, the speed-reduction ratio of a rear-stage portion (first-stage portion) of the first planetary-gear mechanism 31, which comprises the planet gears 311P and the internal gear 311R, differs from the speed-reduction ratio of a front-stage portion (second-stage portion) of the first planetary-gear mechanism 31, which comprises the planet gears 312P and the internal gear 312R. The speed-reduction ratio of the front-stage portion, which comprises the planet gears 312P and the internal gear 312R, is larger than the speed-reduction ratio of the rear-stage portion, which comprises the planet gears 311P and the internal gear 311R. When the pinion gear 31S rotates at a given rotational speed, the rotational speed of the second-stage carrier 312C in the first speed-reducing mode is slower than the rotational speed of the second-stage carrier 312C in the second speed-reducing mode.

In the embodiment, the speed-reduction ratio of the rear-stage portion (first-stage portion) of the first planetary-gear mechanism 31 is 1/4.000, and the speed-reduction ratio of the front-end portion (second-stage portion) is 1/5.429.

In the embodiment, the speed-reduction ratio of the second planetary-gear mechanism 32 and the speed-reduction ratio of the third planetary-gear mechanism 33 are smaller than the speed-reduction ratio of the rear-stage portion (first-stage portion) of the first planetary-gear mechanism 31. The speed-reduction ratio of the second planetary-gear mechanism 32 is smaller than the speed-reduction ratio of the third planetary-gear mechanism 33. In the embodiment, the speed-reduction ratio of the second planetary-gear mechanism 32 is 1/2.857. The speed-reduction ratio of the third planetary-gear mechanism 33 is 1/3.684.

The first change wire 510 is disposed on the outer side of the first casing 4A. The first change wire 510 is movable in the front-rear direction on the outer side of the first casing 4A. A tip portion of the first change wire 510 is inserted into a groove 500A, which is provided on the change ring 500. A through hole 4H is provided in the first casing 4A. The tip portion of the first change wire 510 is disposed on the inner side of the first casing 4A via the through hole 4H. The tip portion of the first change wire 510 is inserted into the groove 500A on the inner side of the first casing 4A. An upper portion of the first change wire 510 is fixed to the first movable member 610. The first movable member 610 is connected to the speed change lever 12. The first movable member 610 is guided in the front-rear direction by a guide rod 600. The guide rod 600 is disposed so as to extend in the front-rear direction. The guide rod 600 is fixed to the casing 4. As shown in FIG. 9, in the embodiment, a rear-end portion of the guide rod 600 is fixed to the bracket plate 4C. A front-end portion of the guide rod 600 is fixed to the second casing 4B. A first guide hole, which extends in the front-rear direction, is formed in the first movable member 610. The guide rod 600 passes through the first guide hole of the first movable member 610. The first spring 630 is a compression spring. A rear-end portion of the first spring 630 is supported on the bracket plate 4C. A front-end portion of the first spring 630 is connected to the first movable member 610. The first spring 630 generates an elastic force such that the first movable member 610 moves (is urged) forward (in one direction). The first spring 630 forwardly biases the change ring 500 via the first movable member 610 and the first change wire 510.

As shown in FIG. 10, cam teeth 311F are provided on an outer-circumferential surface of the internal gear 311R. In addition, cam teeth 312F are also provided on an outer-circumferential surface of the internal gear 312R. The protruding portions 500C are contact members that make contact with any one of the cam teeth 311F of the internal gear 311R and the cam teeth 312F of the internal gear 312R. While being guided by the guide grooves provided on the inner-circumferential surface of the first casing 4A, the protruding portions 500C move between a location opposing the outer-circumferential surface of the internal gear 311R and a location opposing the outer-circumferential surface of the internal gear 312R. Rotation of the internal gear 311R is constrained (blocked, prevented) by the cam teeth 311F and the protruding portions 500C making contact with each other. Rotation of the internal gear 312R is constrained (blocked, prevented) by the cam teeth 312F and the protruding portions 500C making contact with each other.

As shown in FIG. 13, the change ring 500 is connected to the speed change lever 12 via the first change wire 510 and the first movable member 610. When the speed change lever 12 is manipulated (slid), the first movable member 610 moves in the front-rear direction. By manipulating the speed change lever 12 so as to move in the front-rear direction, the first movable member 610 and the first change wire 510 move in the front-rear direction, and the change ring 500 moves in the front-rear direction.

When the first movable member 610, the first change wire 510, and the change ring 500 move forward, the change ring 500 is disposed around the internal gear 312R, and the protruding portions 500C are disposed so as to oppose the outer-circumferential surface of the internal gear 312R, such that the cam teeth 312F and the protruding portions 500C make contact with each other. Thereby, rotation of the internal gear 312R is constrained (blocked, prevented). That is, by moving the first movable member 610, the first change wire 510, and the change ring 500 forward and constraining rotation of the internal gear 312R, the first planetary-gear mechanism 31 is placed in the first speed-reducing mode.

When the first movable member 610, the first change wire 510, and the change ring 500 move rearward, the change ring 500 is disposed around the internal gear 311R, and the protruding portions 500C are disposed so as to oppose the outer-circumferential surface of the internal gear 311R, such that the cam teeth 311F and the protruding portions 500C make contact with each other. Thereby, rotation of the internal gear 311R is constrained. That is, by moving the first movable member 610, the first change wire 510, and the change ring 500 rearward and constraining rotation of the internal gear 311R, the first planetary-gear mechanism 31 is placed in the second speed-reducing mode.

The first movable member 610 is capable of switching the internal gear 311R and the internal gear 312R between a rotationally fixed state and a rotatable state relative to the first casing 4A.

The second speed-changing mechanism 72 can switch between: an enabled mode, in which the speed-reducing function of the second planetary-gear mechanism 32 is enabled; and a disabled mode, in which the speed-reducing function of the second planetary-gear mechanism 32 is disabled. Setting the second planetary-gear mechanism 32 to the enabled mode includes constraining (blocking, preventing) rotation of the internal gear 32R. Setting the second planetary-gear mechanism 32 to the disabled mode includes permitting rotation of the internal gear 32R. By constraining rotation of the internal gear 32R, the second planetary-gear mechanism 32 is placed in the enabled mode. By permitting rotation of the internal gear 32R, the second planetary-gear mechanism 32 is placed in the disabled mode.

Referring again to FIG. 13, the second speed-changing mechanism 72 comprises: a second change wire 520, which is coupled to the internal gear 32R; cam teeth 33F, which are provided on the internal gear 33R; a second movable member 620; and a second spring 640.

Referring now to FIGS. 7 and 13 together, the second change wire 520 is disposed on the outer side of the first casing 4A. The second change wire 520 is movable in the front-rear direction on the outer side of the first casing 4A. A tip portion of the second change wire 520 is inserted into a groove 32E, which is provided on the internal gear 32R. A through hole 4J is provided in the first casing 4A. The tip portion of the second change wire 520 is disposed in the interior of the first casing 4A via the through hole 4J. The tip portion of the second change wire 520 is inserted into the groove 32E in the interior of the first casing 4A. An upper portion of the second change wire 520 is fixed to the second movable member 620. The second movable member 620 is connected to the speed change lever 12. The second movable member 620 is disposed more forward than the first movable member 610. The second movable member 620 is guided in the front-rear direction by the guide rod 600. A second guide hole, which extends in the front-rear direction, is formed in the second movable member 620. The guide rod 600 passes through the second guide hole of the second movable member 620. The second spring 640 is a compression spring. A front-end portion of the second spring 640 is supported on the bracket plate 4B. A rear-end portion of the second spring 640 is connected to the second movable member 620. The second spring 640 generates an elastic force such that the second movable member 620 moves (is urged) rearward (in the other direction). The second spring 640 rearwardly biases the internal gear 32R via the second movable member 620 and the second change wire 520.

Referring again to FIG. 10, cam teeth 32F are provided on the outer-circumferential surface of the internal gear 32R. The cam teeth 32F can mesh with the cam teeth 33F of the internal gear 33R. By inserting the internal gear 32R into the interior of the internal gear 33R, rotation of the internal gear 32R is constrained (blocked, prevented) by the cam teeth 33F of the internal gear 33R.

The internal gear 33R is disposed forward of the internal gear 32R. The internal gear 33R is fixed to the second casing 4B. Cam teeth 33G are provided on the outer-circumferential surface of the internal gear 33R. The cam teeth 33G are respectively inserted into recessed portions provided on (in) the inner-circumferential surface of the second casing 4B. By inserting the cam teeth 33G into the recessed portions provided on the inner-circumferential surface of the second casing 4B, relative movement between the internal gear 33R and the second casing 4B is constrained (blocked, prevented).

When the speed change lever 12 is manipulated (slid), the second movable member 620 moves in the front-rear direction. By manipulating the speed change lever 12 so as to move in the front-rear direction, the second movable member 620 and the second change wire 520 move in the front-rear direction, and the internal gear 32R moves in the front-rear direction. By moving the internal gear 32R in the front-rear direction, the internal gear 32R is switched between the state in which the internal gear 32R is inserted into the internal gear 33R and the state in which the internal gear 32R is removed from the internal gear 33R.

By moving the second movable member 620, the second change wire 520, and the internal gear 32R forward, inserting at least a portion of the internal gear 32R into the interior of the internal gear 33R, and meshing the cam teeth 33F of the internal gear 33R with the cam teeth 32F of the internal gear 32R, rotation of the internal gear 32R is constrained (blocked, prevented). That is, by moving the second movable member 620, the second change wire 520, and the internal gear 32R forward and constraining rotation of the internal gear 32R, the second planetary-gear mechanism 32 is placed in the enabled mode.

By moving the second movable member 620, the second change wire 520, and the internal gear 32R rearward, removing the internal gear 32R from the inner side of the internal gear 33R, and separating the cam teeth 33F of the internal gear 33R from the cam teeth 32F of the internal gear 32R, rotation of the internal gear 32R is permitted. That is, by moving the second movable member 620, the second change wire 520, and the internal gear 32R rearward and permitting rotation of the internal gear 32R, the second planetary-gear mechanism 32 is placed in the disabled mode.

The second movable member 620 is capable of switching the internal gear 32R between a rotationally fixed state and a rotatable state relative to the first casing 4A.

When the second planetary-gear mechanism 32 is in the enabled mode, the internal gear 32R meshes with only the planet gears 32P. When the second planetary-gear mechanism 32 is in the disabled mode, the internal gear 32R meshes with both the planet gears 32P and the second-stage carrier 312C.

As described above, in the embodiment, the speed modes of the speed-reducing mechanism 30 include the low-speed mode (speed “1”), the medium-speed mode (speed “2”), and the high-speed mode (speed “3”).

The movable range of the speed change lever 12 is defined in the front-rear direction. By manipulating (sliding) the speed change lever 12 so as to move to the front portion of the movable range, the speed mode of the speed-reducing mechanism 30 is set to the low-speed mode (speed “1”). By manipulating the speed change lever 12 so as to move to the intermediate portion of the movable range, the speed mode of the speed-reducing mechanism 30 is set to the medium-speed mode (speed “2”). By manipulating the speed change lever 12 so as to move to the rear portion of the movable range, the speed mode of the speed-reducing mechanism 30 is set to the high-speed mode (speed “3”).

The low-speed mode includes the first planetary-gear mechanism 31 being set to the first speed-reducing mode and the second planetary-gear mechanism 32 being set to the enabled mode. By manipulating the speed change lever 12 so as to move to the front portion of the movable range and moving the second movable member 620 forward, the first planetary-gear mechanism 31 is set to the first speed-reducing mode, and the second planetary-gear mechanism 32 is set to the enabled mode. That is, in the low-speed mode (speed “1”), the front-stage portion (second-stage portion) of the first planetary-gear mechanism 31, the second planetary-gear mechanism 32, and the third planetary-gear mechanism 33 are used (enabled).

The medium-speed mode includes the first planetary-gear mechanism 31 being set to the first speed-reducing mode and the second planetary-gear mechanism 32 being set to the disabled mode. By manipulating the speed change lever 12 so as to move to the intermediate portion of the movable range, the first planetary-gear mechanism 31 is set to the first speed-reducing mode, and the second planetary-gear mechanism 32 is set to the disabled mode. That is, in the medium-speed mode (speed “2”), the front-stage portion (second-stage portion) of the first planetary-gear mechanism 31 and the third planetary-gear mechanism 33 are used (enabled).

The high-speed mode includes the first planetary-gear mechanism 31 being set to the second speed-reducing mode and the second planetary-gear mechanism 32 being set to the disabled mode. By manipulating the speed change lever 12 so as to move to the rear portion of the movable range and moving the first movable member 610 rearward, the first planetary-gear mechanism 31 is set to the second speed-reducing mode, and the second planetary-gear mechanism 32 is set to the disabled mode. That is, in the high-speed mode (speed “3”), the rear-stage portion (first-stage portion) of the first planetary-gear mechanism 31 and the third planetary-gear mechanism 33 are used (enabled).

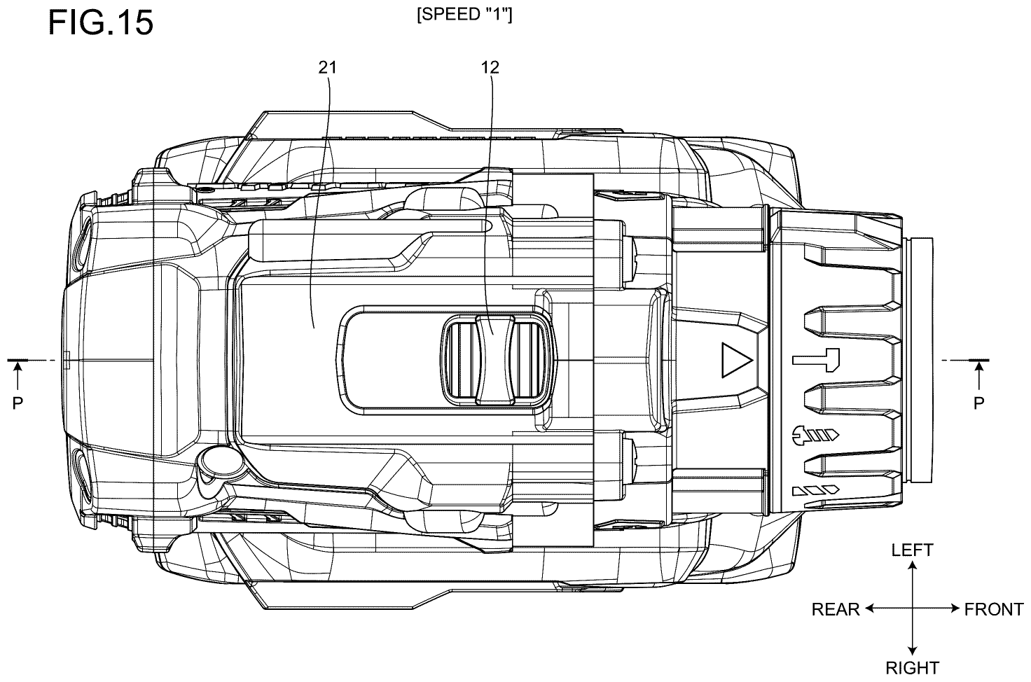

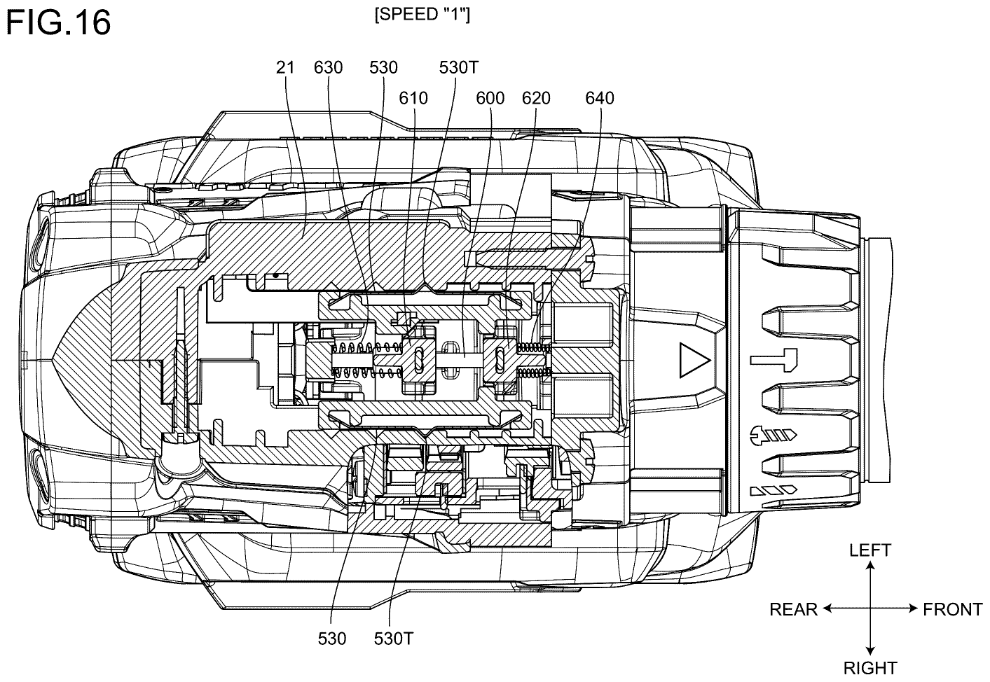

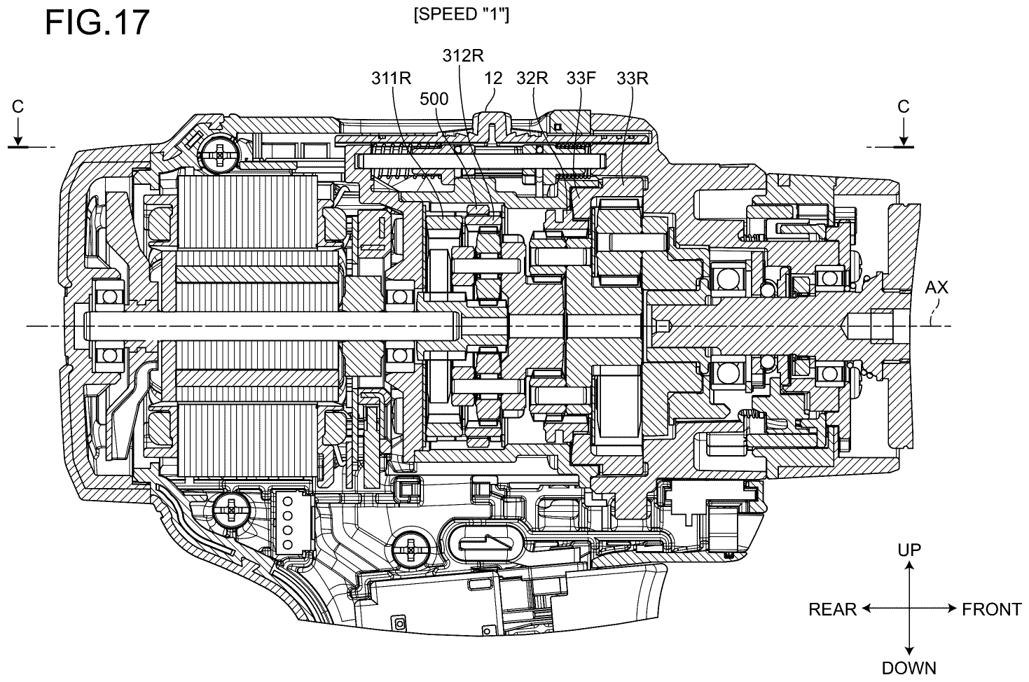

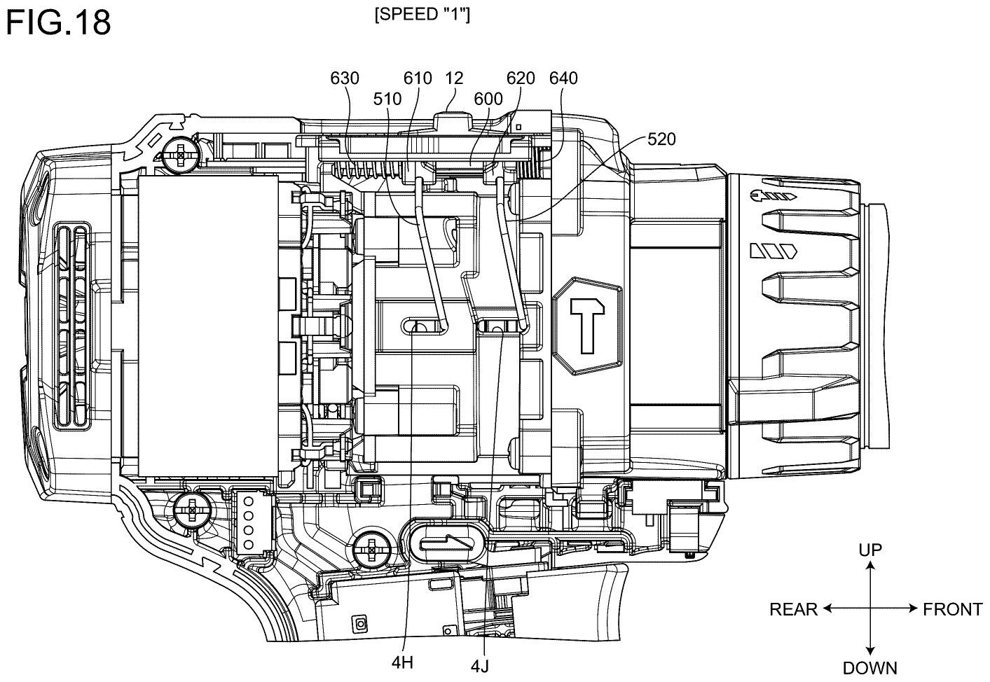

FIG. 15 is a drawing, viewed from above, of the driver-drill 1 when the speed-reducing mechanism 30 has been set to the low-speed mode (speed “1”) according to the embodiment. FIG. 16 is a cross-sectional view that shows the driver-drill 1 when the speed-reducing mechanism 30 has been set to the low-speed mode (speed “1”) according to the embodiment, and corresponds to a cross-sectional auxiliary view taken along line C-C in FIG. 17. FIG. 17 is a cross-sectional view that shows the driver-drill 1 when the speed-reducing mechanism 30 has been set to the low-speed mode (speed “1”) according to the embodiment, and corresponds to a cross-sectional auxiliary view taken along line P-P in FIG. 15. FIG. 18 shows the internal structure of the driver-drill 1 when the speed-reducing mechanism 30 has been set to the low-speed mode (speed “1”) according to the embodiment.

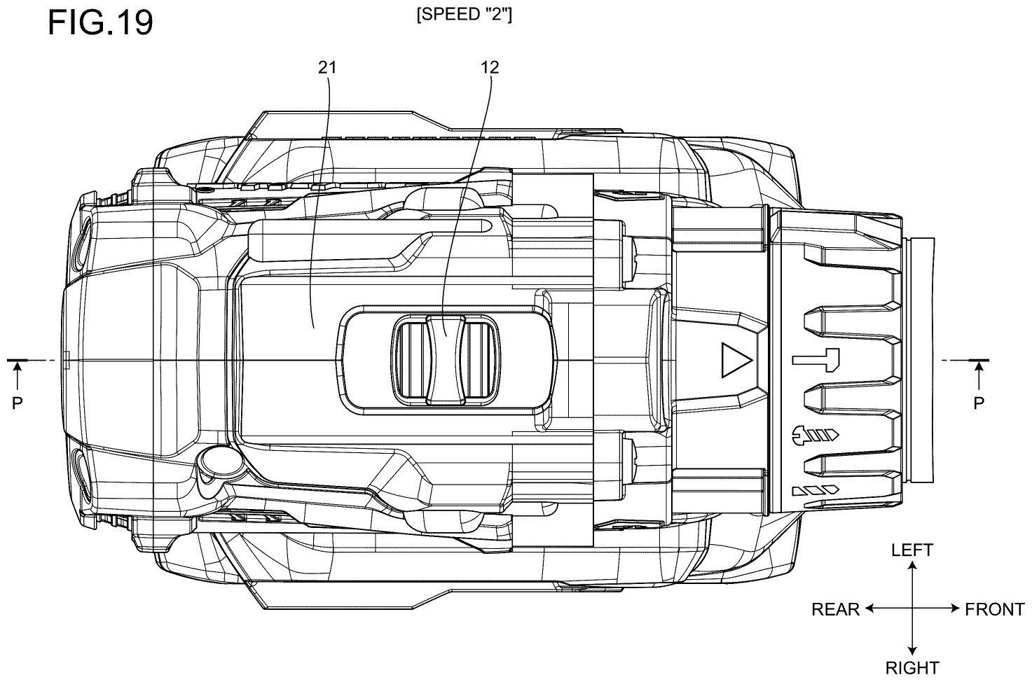

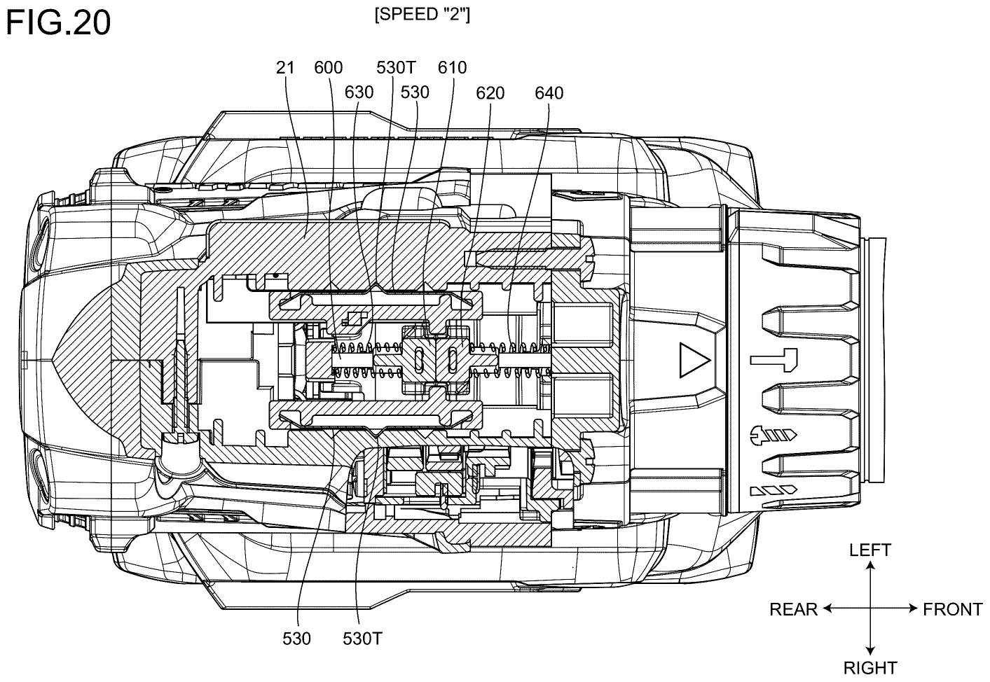

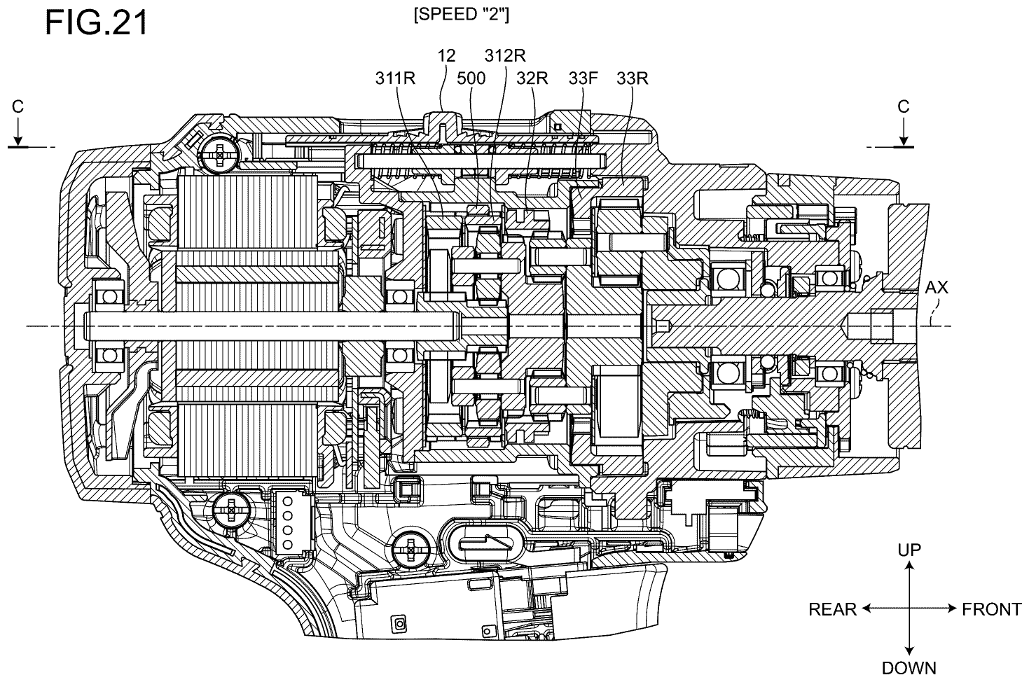

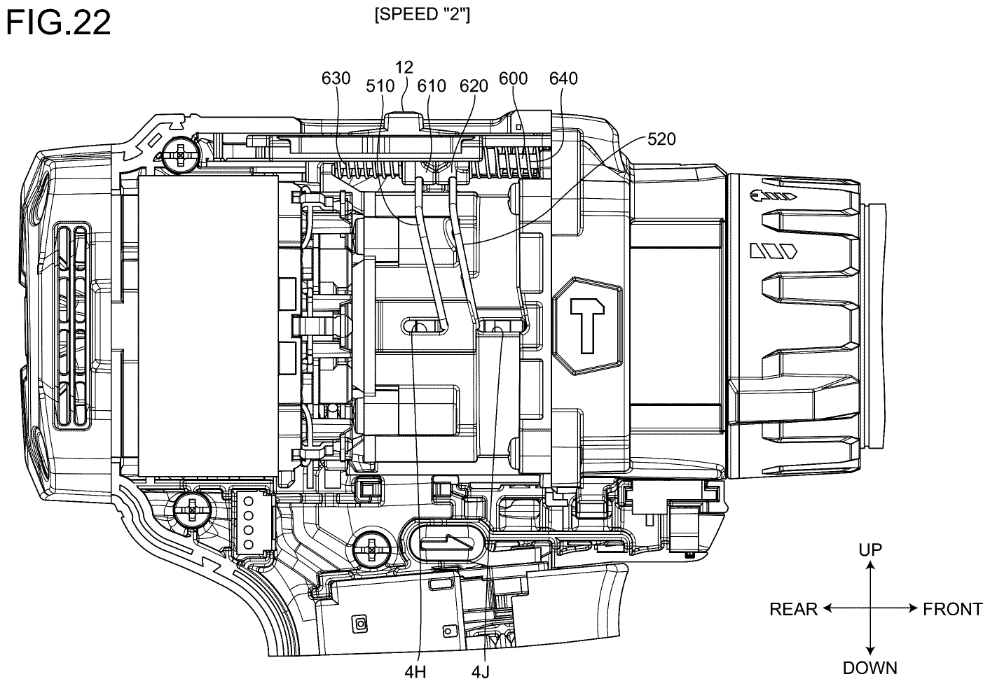

FIG. 19 is a drawing, viewed from above, of the driver-drill 1 when the speed-reducing mechanism 30 has been set to the medium-speed mode (speed “2”) according to the embodiment. FIG. 20 is a cross-sectional view that shows the driver-drill 1 when the speed-reducing mechanism 30 has been set to the medium-speed mode (speed “2”) according to the embodiment, and corresponds to a cross-sectional auxiliary view taken along line C-C in FIG. 21. FIG. 21 is a cross-sectional view that shows the driver-drill 1 when the speed-reducing mechanism 30 has been set to the medium-speed mode (speed “2”) according to the embodiment, and corresponds to a cross-sectional auxiliary view taken along line P-P in FIG. 19. FIG. 22 shows the internal structure of the driver-drill 1 when the speed-reducing mechanism 30 has been set to the medium-speed mode (speed “2”) according to the embodiment.

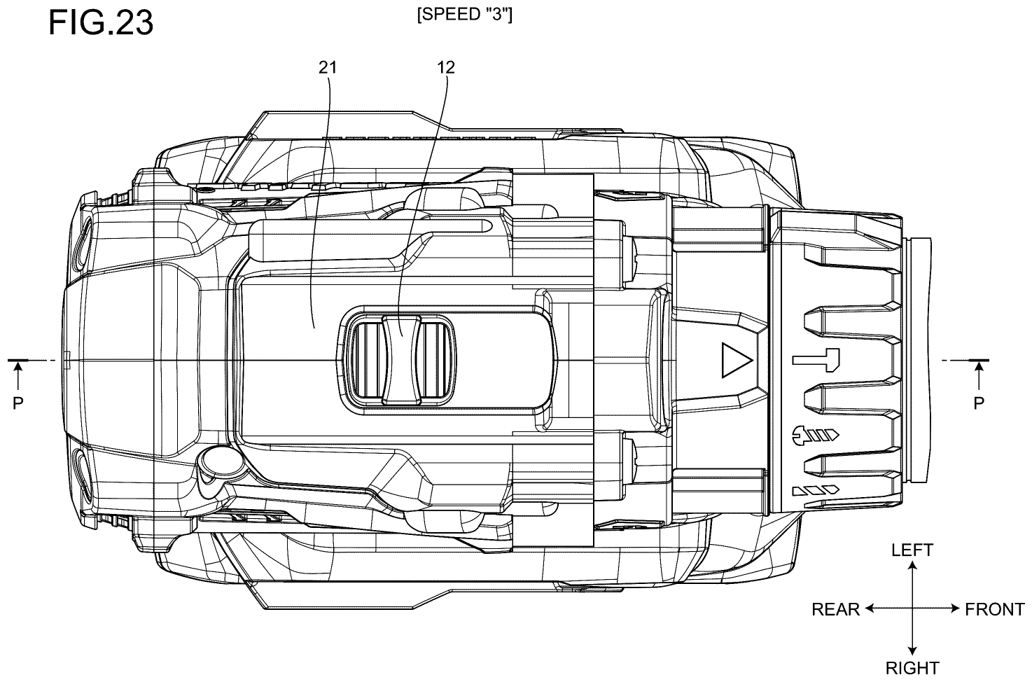

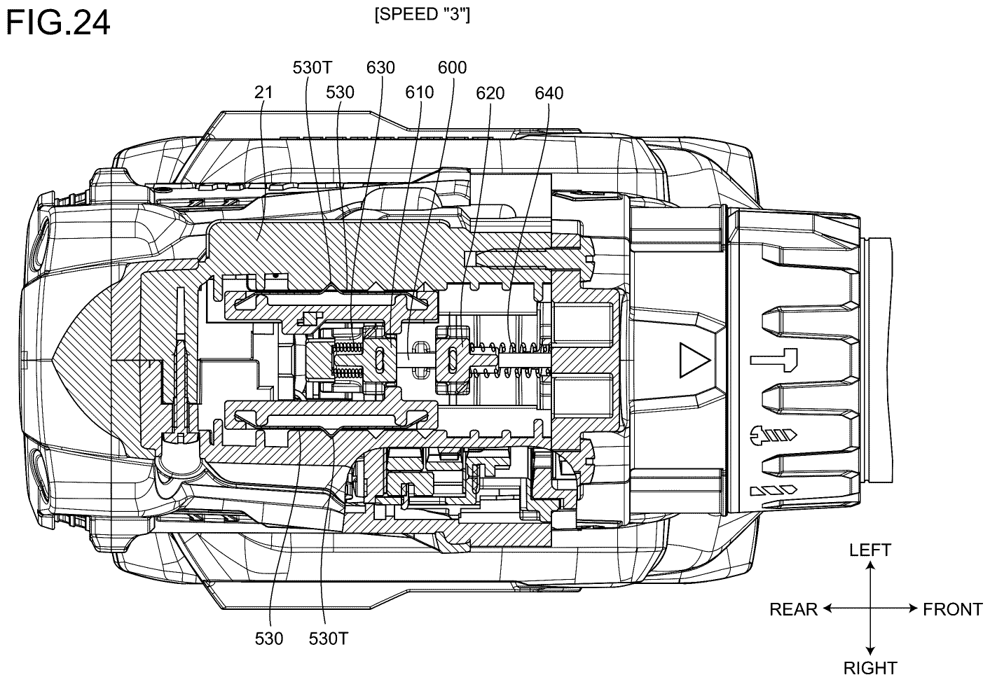

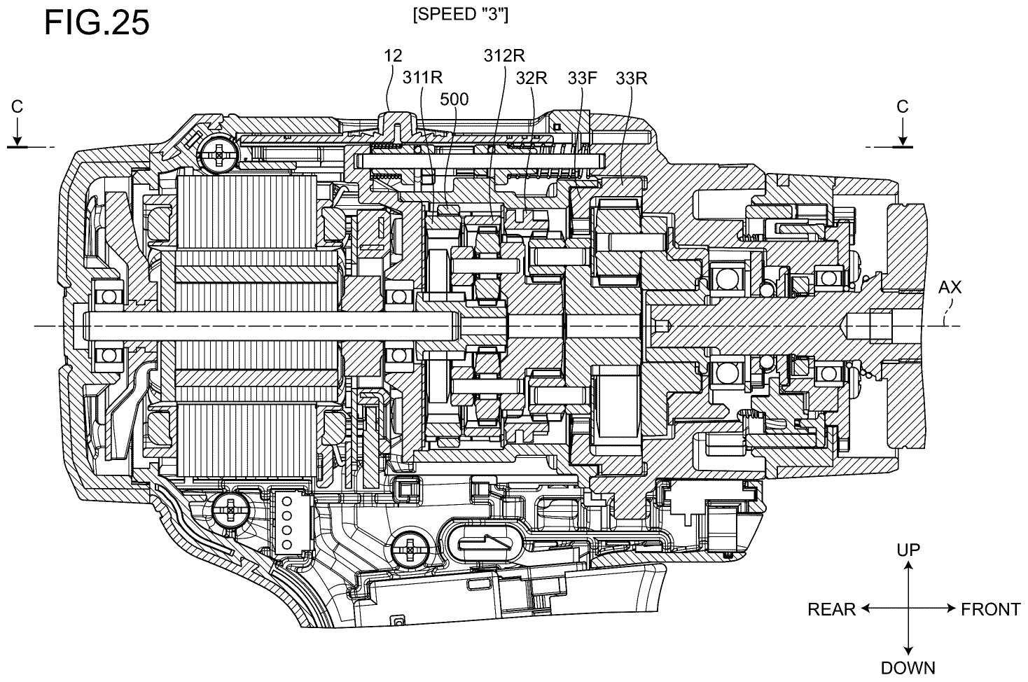

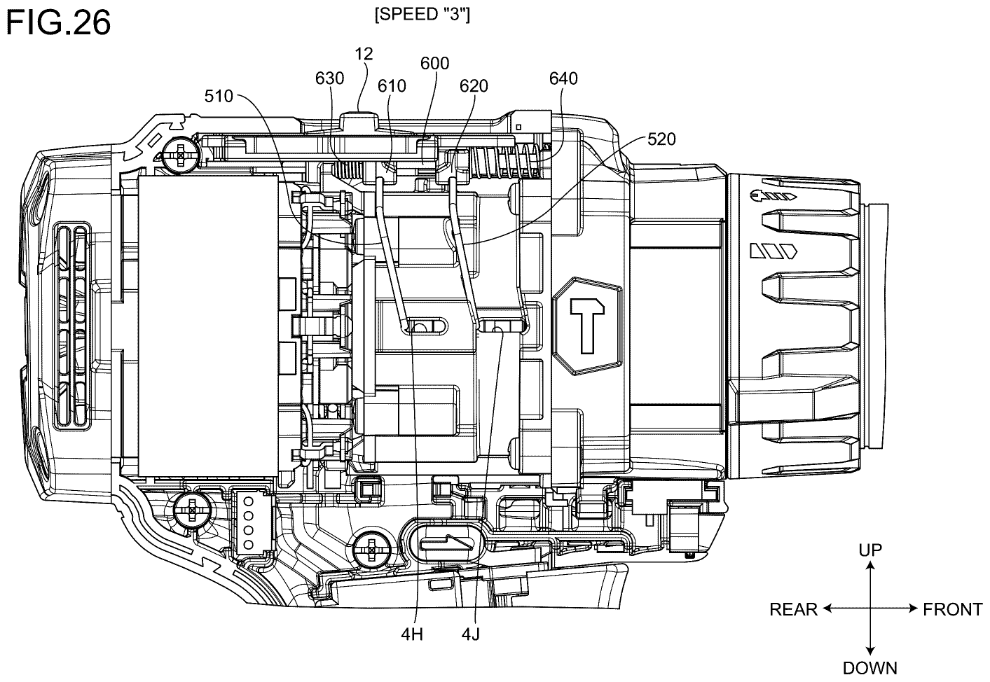

FIG. 23 is a drawing, viewed from above, of the driver-drill 1 when the speed-reducing mechanism 30 has been set to the high-speed mode (speed “3”) according to the embodiment. FIG. 24 is a cross-sectional view that shows the driver-drill 1 when the speed-reducing mechanism 30 has been set to the high-speed mode (speed “3”) according to the embodiment, and corresponds to a cross-sectional auxiliary view taken along line C-C in FIG. 25. FIG. 25 is a cross-sectional view that shows the driver-drill 1 when the speed-reducing mechanism 30 has been set to the high-speed mode (speed “3”) according to the embodiment, and corresponds to a cross-sectional auxiliary view taken along line P-P in FIG. 23. FIG. 26 shows the internal structure of the driver-drill 1 when the speed-reducing mechanism 30 has been set to the high-speed mode (speed “3”) according to the embodiment.

The speed change lever 12 is manipulated by the user such that the first movable member 610 moves in the front-rear direction. The first movable member 610 moves in the front-rear direction while being guided by the guide rod 600. The speed change lever 12 is manipulated by the user such that the second movable member 620 moves in the front-rear direction. The second movable member 620 moves in the front-rear direction while being guided by the guide rod 600. The first spring 630 generates an elastic force such that the first movable member 610 moves (is urged) forward. The second spring 640 generates an elastic force such that the second movable member 620 moves (is urged) rearward.

As shown in FIGS. 15-18, in order to change the speed-reducing mechanism 30 from the medium-speed mode (speed “2”) to the low-speed mode (speed “1”), the user manipulates (slides) the speed change lever 12 against the elastic force (biasing force) of the second spring 640 such that the speed change lever 12 moves forward. By moving the speed change lever 12 forward, the second movable member 620 moves forward against the elastic force of the second spring 640. Leaf springs 530 are fixed to both the left and right sides of the speed change lever 12. By inserting protruding portions 530T of the leaf springs 530 into the recessed portions provided at portions of the motor-housing part 21, the speed change lever 12 is positioned at the speed “1” position. By moving the second movable member 620 forward within the movable range of the second movable member 620, the first planetary-gear mechanism 31 is set to the first speed-reducing mode, in which rotation of the internal gear 312R is constrained (blocked, prevented) and rotation of the internal gear 311R is permitted, and the second planetary-gear mechanism 32 is set to the enabled mode, in which rotation of the internal gear 32R is inhibited.

As shown in FIGS. 23-26, in order to change the speed-reducing mechanism 30 from the medium-speed mode (speed “2”) to the high-speed mode (speed “3”), the user manipulates (slides) the speed change lever 12 against the elastic force (biasing force) of the first spring 630 such that the speed change lever 12 moves rearward. By moving the speed change lever 12 rearward, the first movable member 610 moves rearward against the elastic force of the first spring 630. The leaf springs 530 are fixed to both the left and right sides of the speed change lever 12. By inserting the protruding portions 530T of the leaf springs 530 into the recessed portions provided at portions of the motor-housing part 21, the speed change lever 12 is positioned at the speed “3” position. By moving the first movable member 610 rearward within the movable range of the first movable member 610, the first planetary-gear mechanism 31 is set to the second speed-reducing mode, in which rotation of the internal gear 311R is constrained (blocked, prevented) and rotation of the internal gear 312R is permitted, and the second planetary-gear mechanism 32 is set to the disabled mode, in which rotation of the internal gear 32R is permitted.

As shown in FIGS. 19-22, in order to change the speed-reducing mechanism 30 from the low-speed mode (speed “1”) to the medium-speed mode (speed “2”), the user manipulates (slides) the speed change lever 12 such that the speed change lever 12 moves rearward. The speed change lever 12 and the second movable member 620 can smoothly move rearward owing to the elastic force of the second spring 640. When the speed-reducing mechanism 30 is to be changed from the high-speed mode (speed “3”) to the medium-speed mode (speed “2”), the user manipulates the speed change lever 12 such that the speed change lever 12 moves forward. The speed change lever 12 and the first movable member 610 can smoothly move forward owing to the elastic force of the first spring 630. By moving the first movable member 610 forward within the movable range of the first movable member 610 and moving the second movable member 620 rearward within the movable range of the second movable member 620, the first planetary-gear mechanism 31 is set to the first speed-reducing mode, in which rotation of the internal gear 312R is constrained (blocked, prevented) and rotation of the internal gear 311R is permitted, and the second planetary-gear mechanism 32 is set to the disabled mode, in which rotation of the internal gear 32R is permitted.

### Specifications

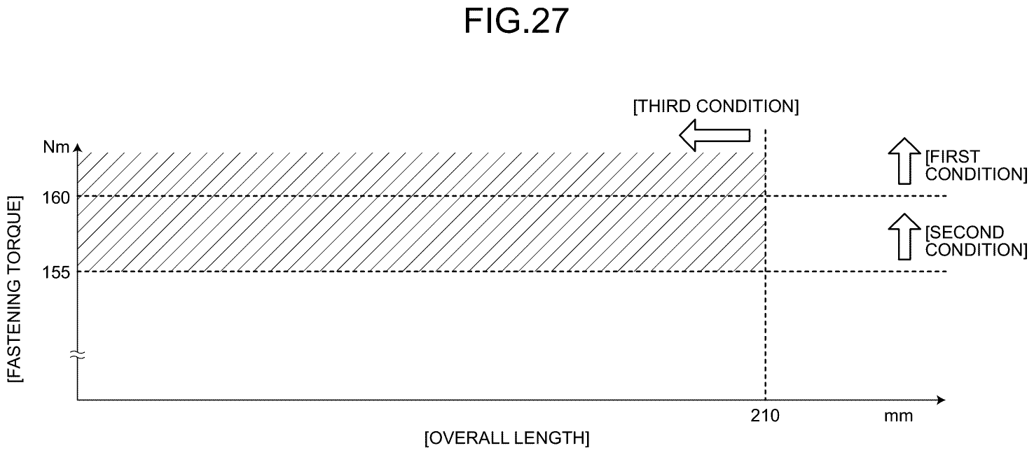

FIG. 27 shows the relationship between the fastening torque and the overall length of the driver-drill 1 according to the embodiment. The fastening torque of the driver-drill 1 refers to the maximum fastening torque of the output part 8. As shown in FIG. 5, overall length LT of the driver-drill 1 refers to the distance in the front-rear direction between the rear-end portion of the enclosing members that enclose the motor 6 and the front-end portion of the chuck 82.

In the embodiment, the driver-drill 1 satisfies Condition 2 and Condition 3 below.

Condition 2: Maximum fastening torque is 155 N·m or more (number of variable-speed stages of the speed-reducing mechanism 30 is three)

Condition 3: Overall length LT is 210 mm or less (number of variable-speed stages of the speed-reducing mechanism 30 is three)

It is noted that the number of variable-speed stages of the speed-reducing mechanism 30 according to the embodiment is three; however, in an embodiment in which the number of variable-speed stages of the speed-reducing mechanism 30 is two, the driver-drill 1 may satisfy Condition 1 below.

Condition 1: Maximum fastening torque is 160 N·m or more (number of variable-speed stages of the speed-reducing mechanism 30 is two)

It is noted that, in an embodiment in which the number of variable-speed stages of the speed-reducing mechanism 30 is three, the driver-drill 1 may satisfy Condition 1 described above.

In Condition 1 and Condition 2, the upper-limit value of the maximum fastening torque is not particularly limited and may be, for example, 250 N·m. That is, the maximum fastening torque of the output part 8 may be 155 N·m or more and 250 N·m or less. The maximum fastening torque of the output part 8 may be 160 N·m or more and 250 N·m or less.

As shown in FIG. 5, in the embodiment, dimension LM of the motor 6 in the front-rear direction is 50 mm. Dimension LG of the power-transmission mechanism 7 in the front-rear direction is 90 mm. Dimension LC of the chuck 82 in the front-rear direction is 50 mm.

In the example shown in FIG. 5, dimension LM of the motor 6 is the distance in the front-rear direction between the rear end of the rotor shaft 63 and the rear end of the bearing 64, which supports the front-end portion of the rotor shaft 63.

Dimension LM of the motor 6 is modifiable between 35 mm and 60 mm. In an embodiment in which this dimension has been made large, the output of the motor 6 becomes large, and the speed-reduction ratio can be made small. In the alternative, in an embodiment in which this dimension has been made small, the output of the motor 6 becomes small, and the speed-reduction ratio is made large. A good value for dimension LM can be selected by investigating the size and speed-reduction ratio of the motor 6.

In case dimension LM of 50 mm is used, it can be said that, within the range of 35 mm to 60 mm, the range of 40 mm to 55 mm is more suitable. Within this range, a suitable value and range can be appropriately selected depending on the application of the present teachings.

When investigating dimension LM of the motor 6, the diameter of the motor 6 is also critical. This is because the output of the motor 6 is qualitatively (proportionally) related to the volume of the motor 6.

The diameter of the motor 6 utilized in the embodiment is 52 mm. However, this diameter can be adjusted in the range of 40 mm to 65 mm. For example, in an embodiment in which the diameter has been made to be 40 mm, dimension LM should be made long. In the alternative, in an embodiment in which the diameter has been made to be, for example, 65 mm, dimension LM can be made small.

In case a diameter of 52 mm is used, it can be said that, within the range of 40 mm to 65 mm, the range of 48 mm to 55 mm is more suitable. Within this range, a suitable value and range can be appropriately selected.

In the example shown in FIG. 5, dimension LG of the power-transmission mechanism 7 is the distance in the front-rear direction between the rear end of the bearing 64 and the front end of the casing 4.

In the example shown in FIG. 5, dimension LC of the chuck 82 is the distance in the front-rear direction between the front end of the casing 4 and the front end of the chuck 82.

In addition, the chuck 82 is mounted at a front-end portion of the spindle 81. As shown in FIG. 9, outer diameter DS of the front-end portion of the spindle 81, on which the chuck 82 is mounted, is 9/16 inch.

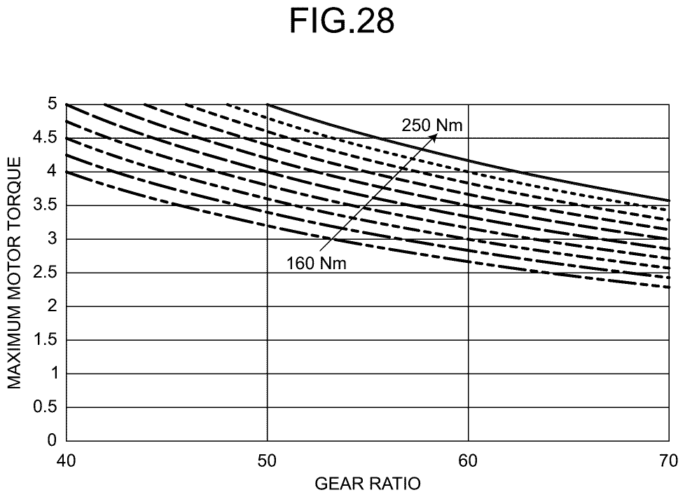

FIG. 28 shows the relationship between the motor torque and the gear ratio of the driver-drill 1 according to the embodiment. The term “motor torque” refers to the output torque of the motor 6. The term “gear ratio” refers to the speed-reduction ratio of the speed-reducing mechanism 30. As shown in FIG. 28, in an embodiment in which the motor torque is large, the maximum fastening torque of the output part 8 can exhibit a large value even if the gear ratio is small. In an embodiment in which the gear ratio is large, the maximum fastening torque of the output part 8 can be a large value even if the motor torque is small.

As described above, the speed-reduction ratio of the rear-stage portion (first-stage portion) of the first planetary-gear mechanism 31 is 1/4.000, and the speed-reduction ratio of the front-stage portion (second-stage portion) is 1/5.429. The speed-reduction ratio of the second planetary-gear mechanism 32 is 1/2.857. The speed-reduction ratio of the third planetary-gear mechanism 33 is 1/3.684. When the speed-reducing mechanism 30 is at (has been set to) speed “1,” the speed-reduction ratio (gear ratio) of the speed-reducing mechanism 30 exhibits its maximum value. The speed-reducing mechanism 30 being at (having been set to) speed “1” means that the front-stage portion (second-stage portion) of the first planetary-gear mechanism 31, the second planetary-gear mechanism 32, and the third planetary-gear mechanism 33 are being used. The speed-reducing mechanism 30 being at (having been set to) speed “2” means that the front-stage portion (second-stage portion) of the first planetary-gear mechanism 31 and the third planetary-gear mechanism 33 are being used. The speed-reducing mechanism 30 being at (having been set to) speed “3” means that the rear-stage portion (first-stage portion) of the first planetary-gear mechanism 31 and the third planetary-gear mechanism 33 are being used.

In the embodiment, the maximum gear ratio of the speed-reducing mechanism 30 is 1/57.14. In the situation in which the maximum gear ratio of the speed-reducing mechanism 30 is 1/57.14, by using the motor 6 having a motor torque of, for example, 2.80014 N·m, the maximum fastening torque of the output part 8 becomes 160 N·m.

### Effects

In the embodiment as explained above, the driver-drill 1 may comprise: the motor 6, which comprises the stator 61 and the rotor 62; the output part 8 comprising: the spindle 81, which is disposed more forward than the motor 6 and, in response to application of a rotational force transmitted from the rotor 62, is rotated around rotational axis AX extending in the front-rear direction; and the chuck 82, which is mounted on the spindle 81; and the speed-reducing mechanism 30, which is configured to rotate the output part 8 at a rotational speed that is lower than the rotational speed of the rotor 62 but at a higher torque. The maximum fastening torque of the output part 8 may be 160 N·m or more.

According to the above-mentioned configuration, the output part 8 of the driver-drill 1 can be driven at a higher torque.

In the embodiment, the speed-reducing mechanism 30 may be a three-stage, variable-speed mechanism.

According to the above-mentioned configuration, the output part 8 will rotate at a suitable torque in accordance with the requirements for a particular operation/processing.

In the embodiment as explained above, the driver-drill 1 may comprise: the motor 6, which comprises the stator 61 and the rotor 62; the output part 8 comprising: the spindle 81, which is disposed more forward than the motor 6 and, in response to application of a rotational force transmitted from the rotor 62, is rotated around rotational axis AX extending in the front-rear direction; and the chuck 82, which is mounted on the spindle 81; and the speed-reducing mechanism 30, which reduces the speed of rotation of the rotor 62 and causes the output part 8 to rotate at a rotational speed that is lower than the rotational speed of the rotor 62 but at a higher torque. The speed-reducing mechanism 30 may be a three-stage, variable-speed mechanism. The maximum fastening torque of the output part 8 may be 155 N·m or more.

According to the above-mentioned configuration, the output part 8 of the driver-drill 1 can be driven at a higher torque.

In the embodiment, the driver-drill 1 may comprise: the motor 6, which comprises the stator 61 and the rotor 62; the output part 8 comprising: the spindle 81, which is disposed more forward than the motor 6 and, in response to application of a rotational force transmitted from the rotor 62, is rotated around rotational axis AX extending in the front-rear direction; and the chuck 82, which is mounted on the spindle 81; the speed-reducing mechanism 30, which reduces the speed of rotation of the rotor 62 and causes the output part 8 to rotate at a rotational speed that is lower than the rotational speed of the rotor 62 but at a higher torque; the motor-housing part 21 and the rear cover 3, which are the enclosing members that cover the periphery and the rear portion of the motor 6; and the casing 4, which is connected to the front portion of the motor-housing part 21 and houses the speed-reducing mechanism 30. The front-end portion of the chuck 82 may be disposed more forward than the casing 4. The speed-reducing mechanism 30 may be a three-stage, variable-speed mechanism. Overall length LT, which is the distance in the front-rear direction between a rear end of the rear cover 3 and a front end of the chuck 82, may be 210 mm or less.

According to the above-mentioned configuration, the overall length of the driver-drill 1 can be shortened.

In the embodiment, the driver-drill 1 may comprise the hammer mechanism 40, which causes the output part 8 to hammer. The casing 4 may house the power-transmission mechanism 7, which comprises the speed-reducing mechanism 30 and the hammer mechanism 40. Dimension LM of the motor 6 in the front-rear direction may be 50 mm. Dimension LG of the power-transmission mechanism 7 in the front-rear direction may be 90 mm. Dimension LC of the chuck 82 in the front-rear direction may be 50 mm.

According to the above-mentioned configuration, the overall length of the driver-drill 1 can be shortened.

In the embodiment, the outer diameter of the spindle 81 on which the chuck 82 is mounted may be 9/16 inch.

According to the above-mentioned configuration, the spindle 81, which has high strength and is adapted to making the output part 8 high torque, is provided.

In the embodiment, the speed-reducing mechanism 30 may comprise: the first planetary-gear mechanism 31 comprising: the first-stage portion comprising the planet gears 311P, which are the plurality of first planet gears disposed around the pinon gear 31S, which is the sun gear rotated by the rotor 62, and the internal gear 311R, which is the first internal gear disposed around the plurality of planet gears 311P; and the second-stage portion, the speed-reduction ratio of which differs from that of the first-stage portion and comprising the planet gears 312P, which are the plurality of second planet gears disposed around the pinion gear 31S, and the internal gear 312R, which is the second internal gear disposed around the plurality of planet gears 312P; the second planetary-gear mechanism 32, which is disposed more forward than the first planetary-gear mechanism 31 and is driven by the rotational force of the first planetary-gear mechanism 31; and the third planetary-gear mechanism 33, which is disposed more forward than the second planetary-gear mechanism 32 and is driven by the rotational force of the second planetary-gear mechanism 32, The output part 8 may be rotated by the rotational force of the rotor 62 transmitted via the third planetary-gear mechanism 33.

According to the above-mentioned configuration, the output part 8 will rotate at a suitable torque in accordance with the requirements for a particular operation/processing.

In the embodiment, the speed-reduction ratio of the second-stage portion may be larger than the speed-reduction ratio of the first-stage portion.

According to the above-mentioned configuration, the output part 8 will rotate at a suitable torque in accordance with the requirements for a particular operation/processing.

In the embodiment, the speed-reduction ratio of the second planetary-gear mechanism 32 and the speed-reduction ratio of the third planetary-gear mechanism 33 may be smaller than the speed-reduction ratio of the first-stage portion. The speed-reduction ratio of the second planetary-gear mechanism 32 may be smaller than the speed-reduction ratio of the third planetary-gear mechanism 33.

According to the above-mentioned configuration, the output part 8 will rotate at a suitable torque in accordance with the requirements for a particular operation/processing.

In the embodiment, the speed-reducing mechanism 30 being at (having been set to) speed “1” may mean that the second-stage portion of the first planetary-gear mechanism 31, the second planetary-gear mechanism 32, and the third planetary-gear mechanism 33 are being used. The speed-reducing mechanism 30 being at (having been set to) speed “2” may mean that the second-stage portion of the first planetary-gear mechanism 31 and the third planetary-gear mechanism 33 are being used. The speed-reducing mechanism 30 being at (having been set to) speed “3” may mean that the first-stage portion of the first planetary-gear mechanism 31 and the third planetary-gear mechanism 33 are being used.

According to the above-mentioned configuration, the output part 8 will rotate at a suitable torque in accordance with the requirements for a particular operation/processing.

### Second Embodiment

A second embodiment will now be explained. In the explanation below, structural elements that are identical or equivalent to those in the embodiment described above are assigned identical symbols, and explanations of those structural elements are abbreviated or omitted.

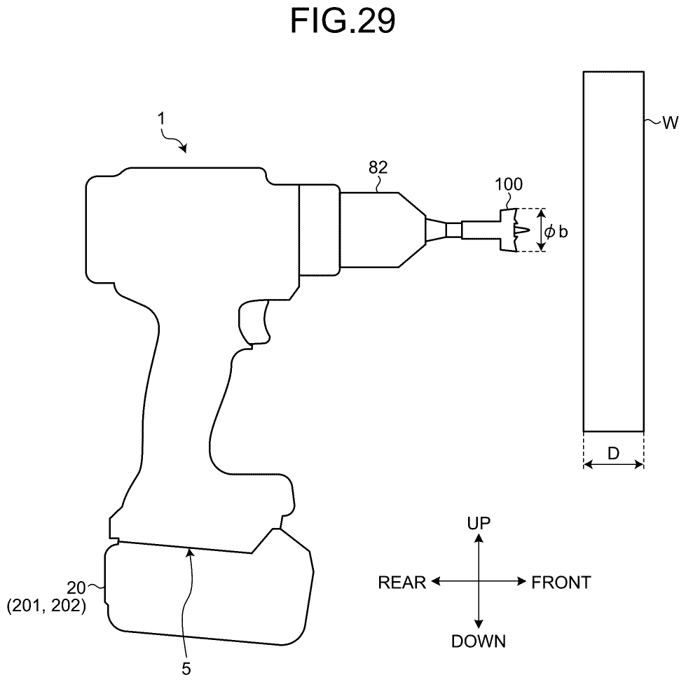

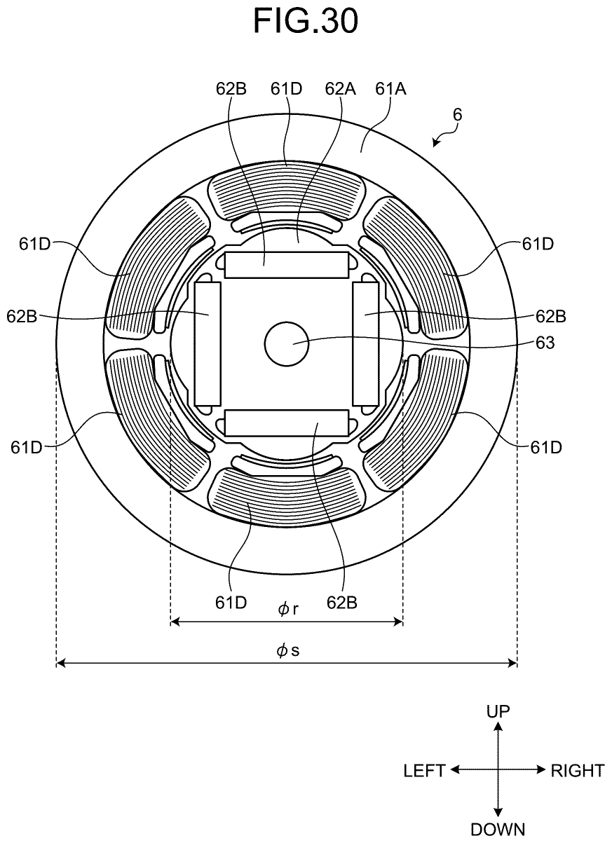

FIG. 29 explains working/operating conditions under which the driver-drill 1 can perform according to the embodiment. The same as in the embodiment described above, the driver-drill 1 comprises: the motor 6, which comprises the stator 61 and the rotor 62; the output part 8 comprising: the spindle 81, which is disposed more forward than the motor 6 and, in response to application of a rotational force transmitted from the rotor 62, is rotated around rotational axis AX extending in the front-rear direction; and the chuck 82, which is mounted on the spindle 81; and the speed-reducing mechanism 30, which reduces the speed of rotation of the rotor 62 and causes the output part 8 to rotate at a rotational speed that is lower than the rotational speed of the rotor 62 but at a higher torque. The speed-reducing mechanism 30 is a three-stage, variable-speed mechanism that includes the low-speed mode, the medium-speed mode, and the high-speed mode. It is noted that, in FIG. 29 and FIG. 30, a detailed illustration of the motor 6, the output part 8, and the speed-reducing mechanism 30 is omitted.

A battery pack 20 is mounted on the battery-mounting part 5. In the embodiment, two types of the battery packs 20 can be used. The battery packs 20 that are mountable on the battery-mounting part 5 include a first battery pack 201 and a second battery pack 202.

The rated voltage of the first battery pack 201 is 40 V, and the battery capacity is 8 Ah. That is, the battery electric-power capacity of the first battery pack 201 is 320 Wh.

The rated voltage of the second battery pack 202 is 40 V, and the battery capacity is 2 Ah. That is, the battery electric-power capacity of the second battery pack 202 is 80 Wh.

During no-load, in which a load is not being applied to the output part 8, the (maximum) rotational speed of the motor 6 is 36,000 rpm.

During no-load in the state in which the first battery pack 201 is mounted on the battery-mounting part 5, the rotational speed (maximum rotational speed) of the output part 8 in the high-speed mode is 2,400 rpm, the rotational speed (maximum rotational speed) of the output part 8 in the medium-speed mode is 1,800 rpm, and the rotational speed (maximum rotational speed) of the output part 8 in the low-speed mode is 650 rpm.

During no-load, the gear ratio of the speed-reducing mechanism 30 in the high-speed mode is 12 or more and 17 or less; in the embodiment, it is 14.74. The gear ratio of the speed-reducing mechanism 30 in the medium-speed mode is 18 or more and 22 or less; in the embodiment, it is 20. The gear ratio of the speed-reducing mechanism 30 in the low-speed mode is 55 or more and 59 or less; in the embodiment, it is 57.14.

In the embodiment, a self-feed bit 100 is held by the chuck 82. Diameter øb of the self-feed bit 100 is 65 mm. When the speed-reducing mechanism 30 is in the high-speed mode, the driver-drill 1 is capable of drilling a hole in Douglas fir W using the self-feed bit 100. Thickness D of Douglas fir W is 30 mm. Douglas fir W (Douglas fir) is a widely used construction material.

FIG. 30 will be used to explain the motor 6 according to the embodiment. In FIG. 30, the motor 6 is illustrated schematically. The motor 6 comprises: the stator core 61A; the coils 61D, which are respectively wound on teeth of the stator core 61A around insulators; the rotor core 62A; the permanent magnets 62B, which are embedded in the rotor core 62A; and the rotor shaft 63, which is fixed to the rotor core 62A. Six of the coils 61D are provided. Four of the permanent magnets 62B are provided.

Outer diameter øs of the stator core 61A is 50 mm or more and 54 mm or less; in the embodiment, it is 52 mm. The length of the stator core 61A in the axial direction is 22 mm or more and 26 mm or less; in the embodiment, it is 24 mm. Outer diameter ør of the rotor core 62A is 24 mm or more and 28 mm or less; in the embodiment, it is 26 mm. The length of the rotor core 62A in the axial direction is 27 mm or more and 31 mm or less; in the embodiment, it is 28.7 mm. The thickness of the wire that constitutes (forms) the coils 61D is 0.6 mm or more and 0.8 mm or less; in the embodiment, it is 0.7 mm. The number of times that the wire is wound around one tooth to form one (each) of the coils 61D is 24 or more and 26 or less; in the embodiment, it is 25.

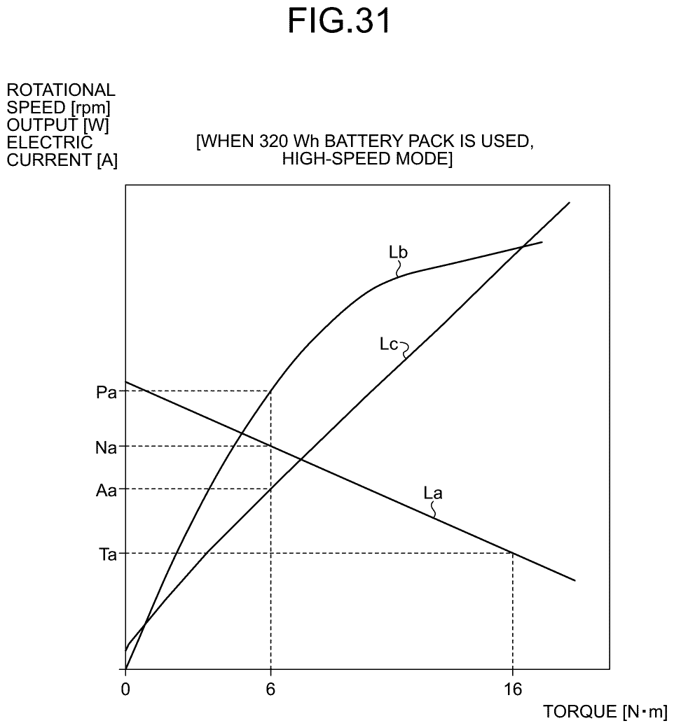

FIG. 31 is a graph that shows the relationship between the torque (maximum torque) and the motor characteristics of the output part 8 in the high-speed mode in the situation in which the first battery pack 201 having a rated voltage of 40 V and a battery capacity of 8 Ah is used according to the embodiment. The graph shown in FIG. 31 shows the relationship between the (maximum) torque and the motor characteristics of the output part 8 when the first battery pack 201 is fully charged.

In FIG. 31, the abscissa represents the (maximum) torque of the output part 8, and the ordinate represents the motor characteristics. The motor characteristics include the rotational speed [rpm] of the output part 8, the output [W] of the motor 6, and the electric current [A] input to the motor 6.

In FIG. 31, line La indicates the relationship between the (maximum) torque of the output part 8 and the rotational speed of the output part 8. Line Lb indicates the relationship between the (maximum) torque of the output part 8 and the output of the motor 6. Line Lc indicates the relationship between the (maximum) torque of the output part 8 and the electric current input to the motor 6.

In the state in which the first battery pack 201 having a rated voltage of 40 V and a battery capacity of 8 Ah (battery electric-power capacity of 320 Wh) is mounted on the battery-mounting part 5, the driver-drill 1 is capable of drilling a hole in Douglas fir W having thickness D of 30 mm using the self-feed bit 100 having diameter ø of 65 mm in the high-speed mode.

In the high-speed mode, the torque of the output part 8 when drilling a hole in Douglas fir W using the self-feed bit 100 is 16 N·m or more. In the high-speed mode, as long as the torque of the output part 8 is 16 N·m or more, a hole can be drilled in Douglas fir W having thickness D of 30 mm using the self-feed bit 100 having diameter ø of 65 mm.

In the high-speed mode, rotational speed Ta of the motor 6 when the torque of the output part 8 is 16 N·m is 900 rpm or more. In the example shown in FIG. 31, rotational speed Ta of the motor 6 is approximately 1,000 rpm when the torque of the output part 8 is 16 N·m.

In the high-speed mode, rotational speed Na of the motor 6 when the torque of the output part 8 is 6 N·m is 1,600 rpm or more. In the example shown in FIG. 31, rotational speed Na of the motor 6 is approximately 1,900 rpm (or more) when the torque of the output part 8 is 6 N·m.

In the high-speed mode, the amount by which the rotational speed of the motor 6 is reduced is 600 rpm or less when the torque of the output part 8 increases from 0 N·m to 6N·m.

In the high-speed mode, electric current Aa input to the motor 6 is 40 A or less when the torque of the output part 8 is 6 N·m. In the example shown in FIG. 31, electric current Aa input to the motor 6 is approximately 38 A when the torque of the output part 8 is 6 N·m.

In the high-speed mode, output Pa of the motor 6 is 1,000 W or more when the torque of the output part 8 is 6 N·m. In the example shown in FIG. 31, output Pa of the motor 6 is approximately 1,150 W when the torque of the output part 8 is 6 N·m.

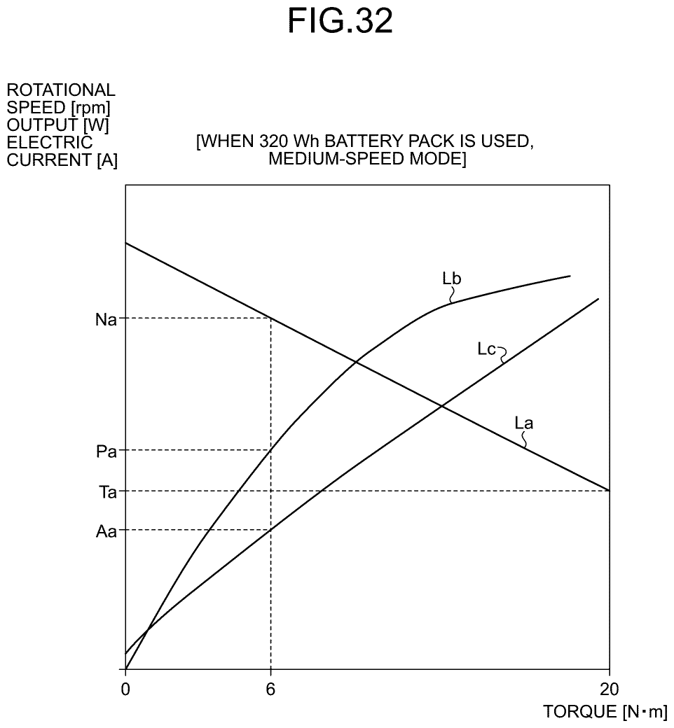

FIG. 32 is a graph that shows the relationship between the (maximum) torque and the motor characteristics of the output part 8 in the medium-speed mode in the situation in which the first battery pack 201 having a rated voltage of 40 V and a battery capacity of 8 Ah is used according to the embodiment. The graph shown in FIG. 32 shows the relationship between the (maximum) torque and the motor characteristics of the output part 8 when the first battery pack 201 is fully charged.

In FIG. 32, the abscissa represents the (maximum) torque of the output part 8, and the ordinate represents the motor characteristics. The motor characteristics include the rotational speed [rpm] of the output part 8, the output [W] of the motor 6, and the electric current [A] input to the motor 6.

In FIG. 32, line La indicates the relationship between the (maximum) torque of the output part 8 and the rotational speed of the output part 8. Line Lb indicates the relationship between the (maximum) torque of the output part 8 and the output of the motor 6. Line Lc indicates the relationship between the (maximum) torque of the output part 8 and the electric current input to the motor 6.

In the state in which the first battery pack 201 having a rated voltage of 40 V and a battery capacity of 8 Ah (battery electric-power capacity of 320 Wh) is mounted on the battery-mounting part 5, the driver-drill 1 is capable of drilling a hole in Douglas fir W having thickness D of 30 mm using the self-feed bit 100 having diameter ø of 65 mm in the medium-speed mode.

In the medium-speed mode, the torque of the output part 8 when drilling a hole in Douglas fir W using the self-feed bit 100 is 16 N·m or more. In the medium-speed mode, in the situation in which the torque of the output part 8 is, for example, 20 N·m, a hole can be drilled in Douglas fir W having thickness D of 30 mm using the self-feed bit 100 having diameter ø of 65 mm. In addition, in the medium-speed mode, in the situation in which the torque of the output part 8 is, for example, 20 N·m, the driver-drill 1 can drill a hole in Douglas fir W, in which thickness D is greater than 30 mm, and can drill a hole in a construction material that is harder than Douglas fir W. In addition, in the medium-speed mode, in the situation in which the torque of the output part 8 is, for example, 20 N·m, the driver-drill 1 can drill a hole in Douglas fir W using the self-feed bit 100, the diameter ø of which is larger than 65 mm.

In the medium-speed mode, rotational speed Ta of the motor 6 when the torque of the output part 8 is 20 N·m is 600 rpm or more. In the example shown in FIG. 32, rotational speed Ta of the motor 6 is approximately 750 rpm when the torque of the output part 8 is 20 N·m.

In the medium-speed mode, rotational speed Na of the motor 6 when the torque of the output part 8 is 6 N·m is 1,000 rpm or more. In the example shown in FIG. 32, rotational speed Na of the motor 6 is approximately 1,450 rpm (or more) when the torque of the output part 8 is 6 N·m.

In the medium-speed mode, the amount by which the rotational speed of the motor 6 is reduced is 600 rpm or less when the torque of the output part 8 increases from 0 N·m to 6 N·m.

In the medium-speed mode, electric current Aa input to the motor 6 is 30 A or less when the torque of the output part 8 is 6 N·m. In the example shown in FIG. 32, electric current Aa input to the motor 6 is approximately 28 A when the torque of the output part 8 is 6 N·m.

In the medium-speed mode, output Pa of the motor 6 is 1700 W or more when the torque of the output part 8 is 6 N·m. In the example shown in FIG. 32, output Pa of the motor 6 is approximately 950 W when the torque of the output part 8 is 6 N·m.

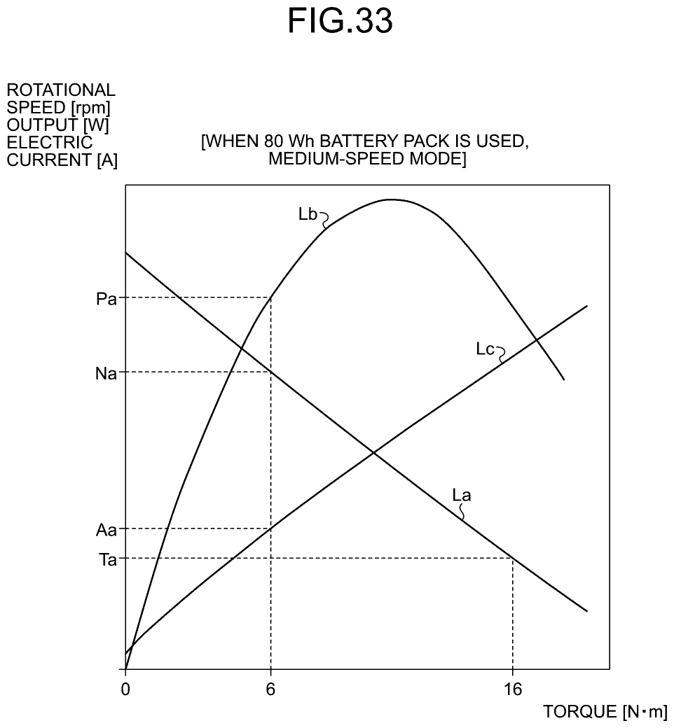

FIG. 33 is a graph that shows the relationship between the (maximum) torque and the motor characteristics of the output part 8 in the medium-speed mode in the situation in which the second battery pack 202 having a rated voltage of 40 V and a battery capacity of 2 Ah is used according to the embodiment. The graph shown in FIG. 33 shows the relationship between the (maximum) torque and the motor characteristics of the output part 8 when the second battery pack 202 is fully charged.

In FIG. 33, the abscissa represents the (maximum) torque of the output part 8, and the ordinate represents the motor characteristics. The motor characteristics include the rotational speed [rpm] of the output part 8, the output [W] of the motor 6, and the electric current [A] input to the motor 6.

In FIG. 33, line La indicates the relationship between the (maximum) torque of the output part 8 and the rotational speed of the output part 8. Line Lb indicates the relationship between the (maximum) torque of the output part 8 and the output of the motor 6. Line Lc indicates the relationship between the (maximum) torque of the output part 8 and the electric current input to the motor 6.

In the state in which the second battery pack 202 having a rated voltage of 40 V and a battery capacity of 2 Ah (battery electric-power capacity of 80 Wh) is mounted on the battery-mounting part 5, the driver-drill 1 is capable of drilling a hole in Douglas fir W having thickness D of 30 mm using the self-feed bit 100 having diameter ø of 65 mm in the medium-speed mode.

In the medium-speed mode, the torque of the output part 8 when drilling a hole in Douglas fir W using the self-feed bit 100 is 16 N·m or more. In the medium-speed mode, in the situation in which the torque of the output part 8 is 16 N·m, a hole can be drilled in Douglas fir W having thickness D of 30 mm using the self-feed bit 100 having diameter ø of 65 mm.

In the medium-speed mode, rotational speed Ta of the motor 6 when the torque of the output part 8 is 16 N·m is 300 rpm or more. In the example shown in FIG. 33, rotational speed Ta of the motor 6 is approximately 450 rpm when the torque of the output part 8 is 16 N·m.

In the medium-speed mode, rotational speed Na of the motor 6 when the torque of the output part 8 is 6 N·m is 1,000 rpm or more. In the example shown in FIG. 33, rotational speed Na of the motor 6 is approximately 1,200 rpm (or more) when the torque of the output part 8 is 6 N·m.

In the medium-speed mode, the amount by which the rotational speed of the motor 6 is reduced is 600 rpm or less when the torque of the output part 8 increases from 0 N·m to 6 N·m.

In the medium-speed mode, electric current Aa input to the motor 6 is 30 A or less when the torque of the output part 8 is 6 N·m. In the example shown in FIG. 33, electric current Aa input to the motor 6 is approximately 28 A when the torque of the output part 8 is 6 N·m.

In the medium-speed mode, output Pa of the motor 6 is 700 W or more when the torque of the output part 8 is 6 N·m. In the example shown in FIG. 33, output Pa of the motor 6 is approximately 760 W when the torque of the output part 8 is 6 N·m.

According to the embodiment as explained above, even for heavy-load work (operation) such as drilling a hole in Douglas fir W having thickness D of 30 mm using the self-feed bit 100 having diameter øb of 65 mm, the driver-drill 1 can perform the heavy-load work in the high-speed mode. Because the driver-drill 1 can generate the torque (approximately 16 N·m) needed for heavy-load work in the high-speed mode, it is possible to avoid a decrease in work efficiency.

### Other Embodiments

In the embodiments described above, it is assumed that the battery pack 20, which is mounted on the battery-mounting part 5, is used as the power supply of the driver-drill 1. However, in modified embodiments according to the present teachings, a commercial power supply (AC power supply) may instead be used as the power supply of the driver-drill 1. In this case, the battery mounting part 5 may be replaced with a power cord and electric plug.

Additional aspects of the present teachings include, but are not limited to:
1. A driver-drill comprising:
   a motor, which comprises a stator and a rotor;
   an output part comprising: a spindle, which is disposed more forward than the motor and, in response to application of a rotational force transmitted from the rotor, is rotated around a rotational axis extending in the front-rear direction; and a chuck, which is mounted on the spindle;
   a speed-reducing mechanism configured to rotate the output part at a rotational speed that is lower than the rotational speed of the rotor but at a higher torque; and
   the battery-mounting part;
   wherein:
   the speed-reducing mechanism is a three-stage, variable-speed mechanism that includes a low-speed mode, a medium-speed mode, and a high-speed mode;
   a self-feed bit having a diameter of 65 mm is held by the chuck;
   in the state in which a battery pack having a battery electric-power capacity of 320 Wh is mounted on the battery-mounting part, in the medium-speed mode, the torque of the output part when drilling a hole in Douglas fir having a thickness of 30 mm using the self-feed bit is 20 N·m or more; and
   in the medium-speed mode, the rotational speed of the motor is 600 rpm or more when the torque of the output part is 20 N·m.
2. The driver-drill according to the above Aspect 1, wherein, in the medium-speed mode, the rotational speed of the motor when the torque of the output part is 6 N·m is 1,000 rpm or more.
3. The driver-drill according to the above Aspect 1, wherein, in the medium-speed mode, the amount by which the rotational speed of the motor is reduced is 600 rpm or less when the torque of the output part increases from 0 N·m to 6 N·m.
4. The driver-drill according to the above Aspect 1, wherein, in the medium-speed mode, the electric current input to the motor is 30 A or less when the torque of the output part is 6 N·m.
5. The driver-drill according to the above Aspect 1, wherein, in the medium-speed mode, the output of the motor is 700 W or more when the torque of the output part is 6 N·m.
6. A driver-drill comprising:
   a motor, which comprises a stator and a rotor;
   an output part comprising: a spindle, which is disposed more forward than the motor and, in response to application of a rotational force transmitted from the rotor, is rotated around a rotational axis extending in the front-rear direction; and a chuck, which is mounted on the spindle;
   a speed-reducing mechanism configured to rotate the output part at a rotational speed that is lower than the rotational speed of the rotor but at a higher torque; and
   the battery-mounting part;
   wherein:
   the speed-reducing mechanism is a three-stage, variable-speed mechanism that includes a low-speed mode, a medium-speed mode, and a high-speed mode;
   a self-feed bit having a diameter of 65 mm is held by the chuck;
   in the state in which a battery pack having a battery electric-power capacity of 80 Wh is mounted on the battery-mounting part, in the medium-speed mode, the torque of the output part when drilling a hole in Douglas fir having a thickness of 30 mm using the self-feed bit is 16 N·m or more; and
   in the medium-speed mode, the rotational speed of the motor is 300 rpm or more when the torque of the output part is 16 N·m.
7. The driver-drill according to the above Aspect 6, wherein, in the medium-speed mode, the rotational speed of the motor when the torque of the output part is 6 N·m is 1,000 rpm or more.
8. The driver-drill according to the above Aspect 6, wherein, in the medium-speed mode, the amount by which the rotational speed of the motor is reduced is 600 rpm or less when the torque of the output part increases from 0 N·m to 6 N·m.
9. The driver-drill according to the above Aspect 6, wherein, in the medium-speed mode, the electric current input to the motor is 30 A or less when the torque of the output part is 6 N·m.
10. The driver-drill according to the above Aspect 6, wherein, in the medium-speed mode, the output of the motor is 700 W or more when the torque of the output part is 6 N·m.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved driver-drills, hammer driver-drills and similar power tools.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1 Driver-drill
2 Housing
2L Left housing
2R Right housing
2S Screw
3 Rear cover
3S Screw
4 Casing
4A First casing
4B Second casing
4C Bracket plate
4D Stop plate
4E Screw
4F Screw
4H Through hole
4J Through hole
4S Screw
5 Battery-mounting part
6 Motor
7 Power-transmission mechanism
8 Output part
9 Fan
10 Trigger lever
11 Forward/reverse-switch lever
12 Speed change lever
13 Action mode changing ring
14 Light
15 Interface panel
16 Dial
17 Controller
18 Air-intake port
19 Air-exhaust port
20 Battery pack
21 Motor-housing part
22 Grip part
23 Battery-holding part
24 Manipulation device
25 Display device
26 Controller case
27 Panel opening
28 Dial opening
30 Speed-reducing mechanism
31 First planetary-gear mechanism
31S Pinion gear
32 Second planetary-gear mechanism
32A Pin
32C Second carrier
32E Groove
32F Cam tooth
32P Planet gear
32R Internal gear
32S Sun gear
33 Third planetary-gear mechanism
33A Pin
33C Third carrier
33F Cam tooth
33G Cam tooth
33P Planet gear
33R Internal gear
33S Sun gear
40 Hammer mechanism
41 First cam
42 Second cam
43 Hammer-change ring
43S Opposing portion
43T Projection portion
44 Stop ring
45 Support ring
46 Steel ball
47 Washer
48 Cam ring
61 Stator
61A Stator core
61B Front insulator
61C Rear insulator
61D Coil
61E Sensor circuit board
61F Short-circuiting member
62 Rotor
62A Rotor core
62B Permanent magnet
71 First speed-changing mechanism
72 Second speed-changing mechanism
63 Rotor shaft
64 Bearing
65 Bearing
81 Spindle
81F Flange portion
81R Screw hole
81T Flat surface
82 Chuck
83 Bearing
84 Bearing
87 Coil spring
100 Self-feed bit
201 First battery pack
202 Second battery pack
311A First pin
311C First-stage carrier
311P Planet gear
312P Planet gear
311R Internal gear
311F Cam tooth
312R Internal gear
311S Large-diameter portion
312A Second pin
312C Second-stage carrier
312F Cam tooth
312S Small-diameter portion
500 Change ring
500A Groove
500B Ring portion
500C Protruding portion
510 First change wire
520 Second change wire
530 Leaf spring
530T Protruding portion
600 Guide rod
610 First movable member
620 Second movable member
630 First spring
640 Second spring
AX
Rotational axis
Douglas fir
W

1. A driver-drill comprising:
a motor, which comprises a stator and a rotor;
an output part comprising: a spindle, which is disposed more forward than the motor and, in response to application of a rotational force transmitted from the rotor, is rotated around a rotational axis extending in the front-rear direction; and a chuck, which is mounted on the spindle; and
a speed-reducing mechanism configured to rotate the output part at a rotational speed that is lower than the rotational speed of the rotor but at a higher torque;
wherein the maximum fastening torque of the output part is 160 N·m or more.

2. The driver-drill according to claim 1, wherein the speed-reducing mechanism is a three-stage, variable-speed mechanism.

3. A driver-drill comprising:
a motor, which comprises a stator and a rotor;
an output part comprising: a spindle, which is disposed more forward than the motor and, in response to application of a rotational force transmitted from the rotor, is rotated around a rotational axis extending in the front-rear direction; and a chuck, which is mounted on the spindle; and
a speed-reducing mechanism configured to rotate the output part at a rotational speed that is lower than the rotational speed of the rotor but at a higher torque;
wherein:
the speed-reducing mechanism is a three-stage, variable-speed mechanism; and
the maximum fastening torque of the output part is 155 N·m or more.

4. The driver-drill according to claim 3, comprising:
an enclosing member, which covers the periphery and a rear portion of the motor; and
a casing, which is connected to a front portion of the enclosing member and houses the speed-reducing mechanism;
wherein:
a front-end portion of the chuck is disposed more forward than the casing; and
an overall length, which is the distance in the front-rear direction between a rear end of the enclosing member and a front end of the chuck, is 210 mm or less.

5. A driver-drill comprising:
a motor, which comprises a stator and a rotor;
an output part comprising: a spindle, which is disposed more forward than the motor and, in response to application of a rotational force transmitted from the rotor, is rotated around a rotational axis extending in the front-rear direction; and a chuck, which is mounted on the spindle;
a speed-reducing mechanism configured to rotate the output part at a rotational speed that is lower than the rotational speed of the rotor but at a higher torque;
an enclosing member, which covers the periphery and a rear portion of the motor; and
a casing, which is connected to a front portion of the enclosing member and houses the speed-reducing mechanism;
wherein:
a front-end portion of the chuck is disposed more forward than the casing;
the speed-reducing mechanism is a three-stage, variable-speed mechanism; and
an overall length, which is the distance in the front-rear direction between a rear end of the enclosing member and a front end of the chuck, is 210 mm or less.

6. The driver-drill according to claim 5, comprising:
a hammer mechanism, which causes the output part to hammer;
wherein:
the casing houses a power-transmission mechanism, which comprises the speed-reducing mechanism and the hammer mechanism;
the dimension of the motor in the front-rear direction is 50 mm;
the dimension of the power-transmission mechanism in the front-rear direction is 90 mm; and
the dimension of the chuck in the front-rear direction is 50 mm.

7. The driver-drill according to claim 5, wherein the outer diameter of the spindle on which the chuck is mounted is 9/16 inch.

8. The driver-drill according to claim 5, wherein:
the speed-reducing mechanism comprises:
a first planetary-gear mechanism comprising: a first-stage portion comprising a plurality of first planet gears disposed around a sun gear rotated by the rotor and a first internal gear disposed around the plurality of first planet gears; and a second-stage portion, which has a speed-reduction ratio that differs from the speed-reduction ratio of the first-stage portion and comprises a plurality of second planet gears disposed around the sun gear and a second internal gear disposed around the plurality of second planet gears;
a second planetary-gear mechanism, which is disposed more forward than the first planetary-gear mechanism and is driven by the rotational force of the first planetary-gear mechanism; and
a third planetary-gear mechanism, which is disposed more forward than the second planetary-gear mechanism and is driven by the rotational force of the second planetary-gear mechanism; and
the output part is rotated by the rotational force of the rotor transmitted via the third planetary-gear mechanism.

9. The driver-drill according to claim 8, wherein the speed-reduction ratio of the second-stage portion is larger than the speed-reduction ratio of the first-stage portion.

10. The driver-drill according to claim 9, wherein:
the speed-reduction ratio of the second planetary-gear mechanism and the speed-reduction ratio of the third planetary-gear mechanism are smaller than the speed-reduction ratio of the first-stage portion; and
the speed-reduction ratio of the second planetary-gear mechanism is smaller than the speed-reduction ratio of the third planetary-gear mechanism.

11. The driver-drill according to claim 10, wherein:
the speed-reducing mechanism being at speed “1” means that the second-stage portion of the first planetary-gear mechanism, the second planetary-gear mechanism, and the third planetary-gear mechanism are being used;
the speed-reducing mechanism being at speed “2” means that the second-stage portion of the first planetary-gear mechanism and the third planetary-gear mechanism are being used; and
the speed-reducing mechanism being at speed “3” means that the first-stage portion of the first planetary-gear mechanism and the third planetary-gear mechanism are being used.

12. A driver-drill comprising:
a motor, which comprises a stator and a rotor;
an output part comprising: a spindle, which is disposed more forward than the motor and, in response to application of a rotational force transmitted from the rotor, is rotated around a rotational axis extending in the front-rear direction; and a chuck, which is mounted on the spindle; and
a speed-reducing mechanism configured to rotate the output part at a rotational speed that is lower than the rotational speed of the rotor but at a higher torque;
wherein:
the speed-reducing mechanism is a three-stage, variable-speed mechanism that includes a low-speed mode, a medium-speed mode, and a high-speed mode;
a self-feed bit having a diameter of 65 mm is held by the chuck; and
in the high-speed mode, the driver-drill is capable of drilling, using the self-feed bit, a hole in Douglas fir having a thickness of 30 mm.

13. The driver-drill according to claim 12, further comprising:
a battery-mounting part;
wherein, in the state in which a battery pack having a rated voltage of 40 V and a battery capacity of 8 Ah is mounted on the battery-mounting part, a hole is drillable in Douglas fir using the self-feed bit in the high-speed mode.

14. The driver-drill according to claim 13, wherein, in the high-speed mode, the torque of the output part when drilling a hole in Douglas fir using the self-feed bit is 16 N·m or more.

15. The driver-drill according to claim 13, wherein, in the high-speed mode, the rotational speed of the motor when the torque of the output part is 16 Nm is 900 rpm or more.

16. The driver-drill according to claim 13, wherein, in the high-speed mode, the rotational speed of the motor when the torque of the output part is 6 N·m is 1,600 rpm or more.

17. The driver-drill according to claim 13, wherein, in the high-speed mode, the amount by which the rotational speed of the motor is reduced is 600 rpm or less when the torque of the output part increases from 0 N·m to 6 N·m.

18. The driver-drill according to claim 13, wherein, in the high-speed mode, the electric current input to the motor is 40 A or less when the torque of the output part is 6 N·m.

19. The driver-drill according to claim 12, wherein, in the high-speed mode, the output of the motor is 1,000 W or more when the torque of the output part is 6 N·m.

20. A driver-drill comprising:
a motor, which comprises a stator and a rotor;
an output part comprising: a spindle, which is disposed more forward than the motor and, in response to application of a rotational force transmitted from the rotor, is rotated around a rotational axis extending in the front-rear direction; and a chuck, which is mounted on the spindle;
a speed-reducing mechanism configured to rotate the output part at a rotational speed that is lower than the rotational speed of the rotor but at a higher torque; and
the battery-mounting part;
wherein:
the speed-reducing mechanism is a three-stage, variable-speed mechanism that includes a low-speed mode, a medium-speed mode, and a high-speed mode;
a self-feed bit having a diameter of 65 mm is held by the chuck;
in the state in which a battery pack having a battery electric-power capacity of 320 Wh is mounted on the battery-mounting part, in the medium-speed mode, the torque of the output part when drilling a hole in Douglas fir having a thickness of 30 mm using the self-feed bit is 20 N·m or more; and
in the medium-speed mode, the rotational speed of the motor is 600 rpm or more when the torque of the output part is 20 N·m.
